(19) United States
(12) Patent Application Publication
(10) Pub. No.: US 2024/0256951 A1
(43) Pub. Date: Aug. 1, 2024

(54) Alert Grouping For Noise Reduction

(71) Applicant: PagerDuty, Inc., San Francisco, CA (US)

(72) Inventor: Weiyu Li, Clarksburg, MD (US)

(21) Appl. No.: 18/160,755

(22) Filed: Jan. 27, 2023

(51) Int. Cl. G06N 20/00

(52) U.S. Cl. CPC G06N 20/00

(57) ABSTRACT

An alert is received. An embedding for the alert is obtained using a machine-learning model. A group of alerts is identified based on the embedding. The alert is added to the group of alerts. The machine-learning model is trained by steps that include obtaining training data. The machine-learning model is trained using the training data to output embedding for alert texts. Each training datum includes a series of alert texts obtained from historical alerts.

### TECHNICAL FIELD

This disclosure relates generally to computer operations and more particularly, but not exclusively to providing real-time management of information technology operations.

### BACKGROUND

Information technology (IT) systems are increasingly becoming complex, multivariate, and in some cases non-intuitive systems with varying degrees of nonlinearity. These complex IT systems may be difficult to model or accurately understand. Various monitoring systems may be arrayed to provide events, alerts, notifications, or the like, in an effort to provide visibility into operational metrics, failures, and/or correctness. However, the sheer size and complexity of these IT systems may result in a flooding of disparate event messages from disparate monitoring/reporting services.

With the increased complexity of distributed computing systems existing event reporting and/or management may not, for example, have the capability to effectively process events in complex and noisy systems. At enterprise scale, IT systems may have millions of components resulting in a complex inter-related set of monitoring systems that report millions of events from disparate subsystems. Manual techniques and pre-programmed rules are labor and computing intensive and expensive, especially in the context of large, centralized IT Operations with overly complex systems distributed across large numbers of components. Further, these manual techniques may limit the ability of systems to scale and evolve for future advances in IT systems capabilities.

### SUMMARY

A first aspect of the disclosed implementations is a method that includes receiving an alert; obtaining, using a machine-learning model, an embedding for the alert; identifying, based on the embedding, a group of alerts; and adding the alert to the group of alerts. The machine-learning model is trained by steps including obtaining training data; and training the machine-learning model using the training data to output embedding for alert texts. Each training datum includes a series of alert texts obtained from historical alerts.

A second aspect of the disclosed implementations is a method that includes receiving an alert; determining, using a text similarly tool and based on a text of the alert, whether the alert matches a group of alerts of groups of alerts; responsive to determining that the alert does not match any of the groups of alerts, determining, using a machine-learning model, whether an embedding corresponding to the alert meets a similarity threshold to a respective embedding of any of the groups of alerts; and, responsive to the embedding meeting the similarity threshold with an embedding of a group of alerts, adding the alert to the group of alerts.

A third aspect of the disclosed implementations is a device that includes a memory and a processor. The processor is configured to execute instructions stored in the memory to receive an alert; obtain, using a machine-learning model, an embedding for the alert, identify, based on the embedding, a group of alerts; and add the alert to the group of alerts. The machine-learning model is trained to obtain training data, where each training datum includes a series of alert texts obtained from historical alerts; and output embedding for alert texts.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 shows components of one embodiment of a computing environment for event management.

FIG. 2 shows one embodiment of a client computer.

FIG. 3 shows one embodiment of a network computer that may at least partially implement one of the various embodiments.

FIG. 4 illustrates a logical architecture of a system 400 for grouping groupable objects.

FIG. 5 is a block diagram of example functionality of a related-objects identifier software.

FIG. 6 illustrates examples 600 of identifying related groupable objects.

FIG. 7 is a block diagram of an example illustrating the operations of a template selector.

FIG. 8 illustrates examples of templates.

FIG. 9 illustrates plots of results of algorithms that generate optimal and sub-optimal templates.

FIG. 10 is a diagram of a technique for training and using a graph-based neural network.

FIGS. 11A-11B illustrate an example of joining groupable data through time.

FIG. 12 illustrates an example of creating a relationship graph.

FIG. 13 is a flowchart of an example of a technique for grouping alerts.

FIG. 14 is a flowchart of an example of another technique for grouping alerts.

FIG. 15 is a flowchart of an example of yet another technique for grouping alerts.

### DETAILED DESCRIPTION

An event management bus (EMB) is a computer system that may be arranged to monitor, manage, or compare the operations of one or more organizations. The EMB may be configured to accept various events that indicate conditions occurring in the one or more organizations. The EMB may be configured to manage several separate organizations at the same time. Briefly, an event can simply be an indication of a state of change to an information technology service of an organization. An event can be or describe a fact at a moment in time that may consist of a single or a group of correlated conditions that have been monitored and classified into an actionable state. As such, a monitoring tool of an organization may detect a condition in the IT environment (e.g. such as the computing devices, network devices, software applications, etc.) of the organization and transmit a corresponding event to the EMB. Depending on the level of impact (e.g., degradation of a service), if any, to one or more constituents of a managed organization, an event may trigger (e.g., may be, may be classified as, may be converted into) an incident. As such, an incident may be an unplanned disruption or degradation of service.

Non-limiting examples of events may include that a monitored operating system process is not running, that a virtual machine is restarting, that disk space on a certain device is low, that processor utilization on a certain device is higher than a threshold, that a shopping cart service of an e-commerce site is unavailable, that a digital certificate has or is expiring, that a certain web server is returning a 703 error code (indicating that web server is not ready to handle requests), that a customer relationship management (CRM) system is down (e.g., unavailable) such as because it is not responding to ping requests, and so on.

At a high level, an event may be received at an ingestion software of the EMB, accepted by the ingestion software, queued for processing, and then processed. Processing an event can include triggering (e.g., creating, generating, instantiating, etc.) a corresponding alert and a corresponding incident in the EMB, sending a notification of the incident to a responder (i.e., a person, a group of persons, etc.), and/or triggering a response (e.g., a resolution) to the incident. An alert (an alert object) may be created (instantiated) for anything that requires a human to perform an action. Thus, the alert may embody or include the action to be performed.

An incident associated with an alert may or may be used to notify the responder who can acknowledge (e.g., assume responsibility for resolving) and resolve the incident. An acknowledged incident is an incident that is being worked on but is not yet resolved. The user that acknowledges an incident may be said to claim ownership of the incident, which may halt any established escalation processes. As such, notifications provide a way for responders to acknowledge that they are working on an incident or that the incident has been resolved. The responder may indicate that the responder resolved the incident using an interface (e.g., a graphical user interface) of the EMB.

On any given day, a plethora of alerts may be triggered due to received events. Additionally, a single event in a managed environment may have a cascading effect such that the event may cause other events, which in turn may cause other events, and so on, therewith resulting in an alert or incident storm (e.g., a significantly high number of alerts or incidents received within a period of time and having the same or related causes or symptoms). Additionally, the same event may be repeatedly received so long as the underlying condition persists. As such, some events may be similar, related, or correlated (collectively, related events) and it would be desirable to identify and group such related events.

However, existing systems may lack the technical capabilities to identify related events. Existing computer systems may not be able to efficiently identify similarities, relationships, and/or correlations between events. Such systems may treat events or alerts as unrelated to any other events or alerts and may cause each event or alert to trigger a separate, corresponding incident. Triggering separate incidents wastes computational resources of (e.g., associated with or used by) the EMB because responders may use the computational resources to investigate and resolve the separate alerts or incidents. Additionally, that responders have to manage (e.g., handle, respond to, debug, identify root cases, and/or implement fixes) the separate incidents results in ineffective and/or untimely resolution of incidents.

In turn, the ineffective and/or untimely resolution of incidents can lead to reduced uptime(s), and thus degraded performance, of computing resources. The possibility of degraded performance may also include substantially increased investment (such as to compensate for the degradation) in processing, memory, and storage resources and may also result in increased energy expenditures (needed to operate those increased processing, memory, and storage resources, and for the network transmission of the database commands) and associated emissions that may result from the generation of that energy.

Implementations according to this disclosure can identify similarities, associations, and correlations between events or alerts and group such related events or alerts together. While this disclosure is mainly discussed with respect to grouping alerts, the disclosure is not so limited. The teachings disclosed herein can be applied to any objects that are to be grouped based on textual similarities, correlations, or some relatedness criteria, or a combination thereof. Such objects are referred herein a “groupable objects.” As such, a groupable object is one that can be grouped with other similar objects of the same type for the purpose of reducing the number of associated downstream objects or entities. For example, by grouping events into groups, the number of triggered alerts can be reduced; and by grouping alerts, the number of triggered incidents can be reduced.

Grouping related events can include limiting the number of incidents triggered from the related events. In an example, only one incident may be triggered for related (i.e., grouped) events. To illustrate, in response to receiving an initial event that cannot be grouped with other currently unresolved events or incidents, a corresponding incident may be triggered. Subsequently received events that are determined to be related to the initial event can be grouped with the initial event and no new incidents are triggered for them. Rather, the corresponding incident is the incident that is considered to be triggered for these subsequently received events. User interfaces of the EMB can be used by a responder assigned to the corresponding incident to view all the grouped events associated with (e.g., grouped under) the corresponding incident. That is, a group of related alerts can be grouped into a single, open incident.

In an example, the EMB can be configured with explicit rules (referred to herein as content-based alert grouping rules (CBAG rules)), which the EMB can use in the grouping of alerts. In an example, text similarity techniques can be used to identify related alerts and group such related alerts. However, in some situations, it may not be possible to identify related events using CBAG rules or text similarities. For example, two events may be semantically, situationally, or temporally (but not textually) related. As another example, different tools or programmers may use different styles or coding standards for events (e.g., titles therefor) received by the EMB. In such a situation (e.g., where CBAG rules and text similarities cannot identify related object), machine learning (ML) can be used to identify related alerts (again, more generally, groupable objects). In an example, and as further described herein, a graph-based neural network can be used to convert alerts into respective embeddings, which is a vectorization technique that gives similar representations to words (or sequences of words) that have similar meanings. Implementations according to this disclosure can use one or more of CBAG rules, text similarity techniques, machine learning, or any combination thereof to group alerts therewith reducing the number of incidents triggered by alerts.

Alert grouping can minimize noise associated with the creation of alerts and incidents. That is, alert grouping can reduce the amount of noise that responders must contend with and allows the responders to focus on a task at hand. Reducing noise can decrease overall total time spent in incident response at least because responders need not shift their focus between many alerts and incidents. Without alert grouping, each alert (or incident) may have to be assigned to a responder (or team of responders) therewith reducing availability of responders to respond to additional incoming alerts. By grouping alerts, the number of responders that are called in (i.e., notified) to deal with the group of alerts can be significantly less than the number of responders involved in resolving each of the events of the group.

As already mentioned, the disclosure herein uses the term “groupable object.” A groupable object can be a construct of the EMB with which a reason for and/or a cause of can be determined, and/or a resolution thereto can be marked. No particular semantics are intended to be attached to the term “object” in “groupable object.” A groupable object can be any entity of the EMB that may be associated with a class (such as in the case of object-oriented programming), a data structure that may include metadata (e.g. attributes, fields, etc.), a set of data elements (elementary or otherwise) that can collectively represent the groupable object. A groupable object can be an object of (e.g., triggered in, created in, received by, etc.) the EMB, or an object related thereto, about which a notification may be transmitted to a responder, with respect to which a responder may directly or indirectly enter an acknowledgement, with respect to which a responder may directly or indirectly enter or indicate a resolution, based on which a responder may perform an action, or a combination thereof. Examples of groupable objects can include events and alerts.

The term “organization” or “managed organization” as used herein refers to a business, a company, an association, an enterprise, a confederation, or the like.

The term “event,” as used herein, can refer to one or more outcomes, conditions, or occurrences that may be detected (e.g., observed, identified, noticed, monitored, etc.) by an event management bus. An event management bus (which can also be referred to as an event ingestion and processing system) may be configured to monitor various types of events depending on needs of an industry and/or technology area. For example, information technology services may generate events in response to one or more conditions, such as, computers going offline, memory overutilization, CPU overutilization, storage quotas being met or exceeded, applications failing or otherwise becoming unavailable, networking problems (e.g., latency, excess traffic, unexpected lack of traffic, intrusion attempts, or the like), electrical problems (e.g., power outages, voltage fluctuations, or the like), customer service requests, or the like, or combination thereof.

Events may be provided to the event management bus using one or more messages, emails, telephone calls, library function calls, application programming interface (API) calls, including, any signals provided to an event management bus indicating that an event has occurred. One or more third party and/or external systems may be configured to generate event messages that are provided to the event management bus.

The term “responder” as used herein can refer to a person or entity, represented or identified by persons, that may be responsible for responding to an event associated with a monitored application or service. A responder is responsible for responding to one or more notification events. For example, responders may be members of an information technology (IT) team providing support to employees of a company. Responders may be notified if an event or incident they are responsible for handling at that time is encountered. In some embodiments, a scheduler application may be arranged to associate one or more responders with times that they are responsible for handling particular events (.e.g., times when they are on-call to maintain various IT services for a company). A responder that is determined to be responsible for handling a particular event may be referred to as a responsible responder. Responsible responders may be considered to be on-call and/or active during the period of time they are designated by the schedule to be available.

The term “incident” as used herein can refer to a condition or state in the managed networking environments that requires some form of resolution by a user or automated service. Typically, incidents may be a failure or error that occurs in the operation of a managed network and/or computing environment. One or more events may be associated with one or more incidents. However, not all events are associated with incidents.

The term “incident response” as used herein can refer to the actions, resources, services, messages, notifications, alerts, events, or the like, related to resolving one or more incidents. Accordingly, services that may be impacted by a pending incident, may be added to the incident response associated with the incident. Likewise, resources responsible for supporting or maintaining the services may also be added to the incident response. Further, log entries, journal entries, notes, timelines, task lists, status information, or the like, may be part of an incident response.

The term “notification message,” “notification event,” or “notification” as used herein can refer to a communication provided by an incident management system to a message provider for delivery to one or more responsible resources or responders. A notification event may be used to inform one or more responsible resources that one or more event messages were received. For example, in at least one of the various embodiments, notification messages may be provided to the one or more responsible resources using SMS texts, MMS texts, email, Instant Messages, mobile device push notifications, HTTP requests, voice calls (telephone calls, Voice Over IP calls (VOIP), or the like), library function calls, API calls, URLs, audio alerts, haptic alerts, other signals, or the like, or combination thereof.

The term “team” or “group” as used herein refers to one or more responders that may be jointly responsible for maintaining or supporting one or more services or system for an organization.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

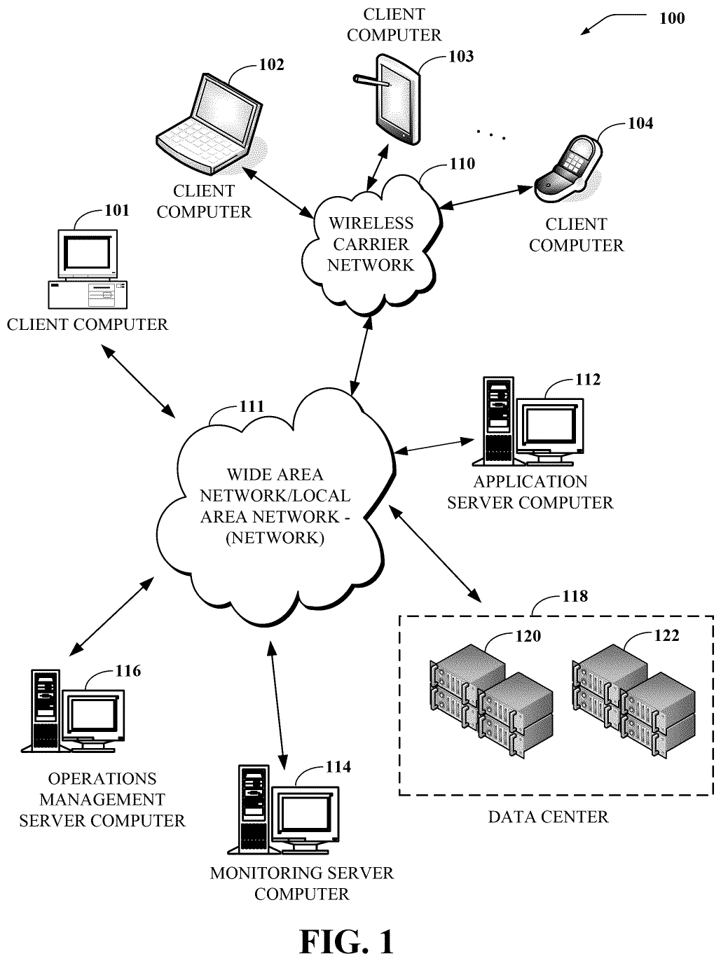

FIG. 1 shows components of one embodiment of a computing environment 100 for event management. Not all the components may be required to practice various embodiments, and variations in the arrangement and type of the components may be made. As shown, the computing environment 100 includes local area networks (LANs)/wide area networks (WANs) (i.e., a network 111), a wireless network 110, client computers 101-104, an application server computer 112, a monitoring server computer 114, and an operations management server computer 116, which may be or may implement an EMB.

Generally, the client computers 102-104 may include virtually any portable computing device capable of receiving and sending a message over a network, such as the network 111, the wireless network 110, or the like. The client computers 102-104 may also be described generally as client computers that are configured to be portable. Thus, the client computers 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDA's), handheld computers, laptop computers, wearable computers, tablet computers, integrated devices combining one or more of the preceding devices, or the like. Likewise, the client computers 102-104 may include Internet-of-Things (IoT) devices as well. Accordingly, the client computers 102-104 typically range widely in terms of capabilities and features. For example, a cell phone may have a numeric keypad and a few lines of monochrome Liquid Crystal Display (LCD) on which only text may be displayed. In another example, a mobile device may have a touch sensitive screen, a stylus, and several lines of color LCD in which both text and graphics may be displayed.

The client computer 101 may include virtually any computing device capable of communicating over a network to send and receive information, including messaging, performing various online actions, or the like. The set of such devices may include devices that typically connect using a wired or wireless communications medium such as personal computers, multiprocessor systems, microprocessor-based or programmable consumer electronics, network Personal Computers (PCs), or the like. In one embodiment, at least some of the client computers 102-104 may operate over wired and/or wireless network. Today, many of these devices include a capability to access and/or otherwise communicate over a network such as the network 111 and/or the wireless network 110. Moreover, the client computers 102-104 may access various computing applications, including a browser, or other web-based application.

In one embodiment, one or more of the client computers 101-104 may be configured to operate within a business or other entity to perform a variety of services for the business or other entity. For example, a client of the client computers 101-104 may be configured to operate as a web server, an accounting server, a production server, an inventory server, or the like. However, the client computers 101-104 are not constrained to these services and may also be employed, for example, as an end-user computing node, in other embodiments. Further, it should be recognized that more or less client computers may be included within a system such as described herein, and embodiments are therefore not constrained by the number or type of client computers employed.

A web-enabled client computer may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, or the like, to display and send a message. In one embodiment, a user of the client computer may employ the browser application to perform various actions over a network.

The client computers 101-104 also may include at least one other client application that is configured to receive and/or send data, operations information, between another computing device. The client application may include a capability to provide requests and/or receive data relating to managing, operating, or configuring the operations management server computer 116.

The wireless network 110 can be configured to couple the client computers 102-104 with network 111. The wireless network 110 may include any of a variety of wireless sub-networks that may further overlay stand-alone ad-hoc networks, or the like, to provide an infrastructure-oriented connection for the client computers 102-104. Such sub-networks may include mesh networks, Wireless LAN (WLAN) networks, cellular networks, or the like.

The wireless network 110 may further include an autonomous system of terminals, gateways, routers, or the like connected by wireless radio links, or the like. These connectors may be configured to move freely and randomly and organize themselves arbitrarily, such that the topology of the wireless network 110 may change rapidly.

The wireless network 110 may further employ a plurality of access technologies including 2nd (2G), 3rd (3G), 4th (4G), 5th (5G) generation radio access for cellular systems, WLAN, Wireless Router (WR) mesh, or the like. Access technologies such as 2G, 3G, 4G, and future access networks may enable wide area coverage for mobile devices, such as the client computers 102-104 with various degrees of mobility. For example, the wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), or the like. The wireless network 110 may include virtually any wireless communication mechanism by which information may travel between the client computers 102-104 and another computing device, network, or the like.

The network 111 can be configured to couple network devices with other computing devices, including, the operations management server computer 116, the monitoring server computer 114, the application server computer 112, the client computer 101, and through the wireless network 110 to the client computers 102-104. The network 111 can be enabled to employ any form of computer readable media for communicating information from one electronic device to another. Also, the network 111 can include the internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. For example, various Internet Protocols (IP), Open Systems Interconnection (OSI) architectures, and/or other communication protocols, architectures, models, and/or standards, may also be employed within the network 111 and the wireless network 110. Furthermore, remote computers and other related electronic devices could be remotely connected to either LANs or WANs via a modem and temporary telephone link. The network 111 can include any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media. Such communication media is distinct from, however, computer-readable devices described in more detail below.

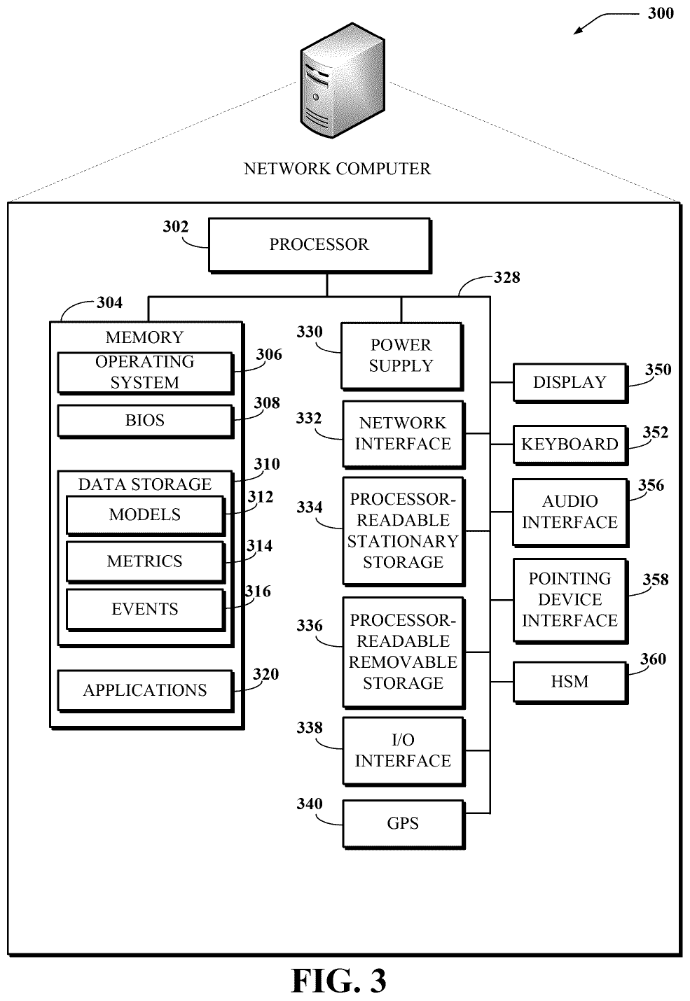

The operations management server computer 116 may include virtually any network computer usable to provide computer operations management services, such as a network computer, as described with respect to FIG. 3. In one embodiment, the operations management server computer 116 employs various techniques for managing the operations of computer operations, networking performance, customer service, customer support, resource schedules and notification policies, event management, or the like. Also, the operations management server computer 116 may be arranged to interface/integrate with one or more external systems such as telephony carriers, email systems, web services, or the like, to perform computer operations management. Further, the operations management server computer 116 may obtain various events and/or performance metrics collected by other systems, such as, the monitoring server computer 114.

In at least one of the various embodiments, the monitoring server computer 114 represents various computers that may be arranged to monitor the performance of computer operations for an entity (e.g., company or enterprise). For example, the monitoring server computer 114 may be arranged to monitor whether applications/systems are operational, network performance, trouble tickets and/or their resolution, or the like. In some embodiments, one or more of the functions of the monitoring server computer 114 may be performed by the operations management server computer 116.

Devices that may operate as the operations management server computer 116 include various network computers, including, but not limited to personal computers, desktop computers, multiprocessor systems, microprocessor-based or programmable consumer electronics, network PCs, server devices, network appliances, or the like. It should be noted that while the operations management server computer 116 is illustrated as a single network computer, the invention is not so limited. Thus, the operations management server computer 116 may represent a plurality of network computers. For example, in one embodiment, the operations management server computer 116 may be distributed over a plurality of network computers and/or implemented using cloud architecture.

Moreover, the operations management server computer 116 is not limited to a particular configuration. Thus, the operations management server computer 116 may operate using a master/slave approach over a plurality of network computers, within a cluster, a peer-to-peer architecture, and/or any of a variety of other architectures.

In some embodiments, one or more data centers, such as a data center 118, may be communicatively coupled to the wireless network 110 and/or the network 111. In at least one of the various embodiments, the data center 118 may be a portion of a private data center, public data center, public cloud environment, or private cloud environment. In some embodiments, the data center 118 may be a server room/data center that is physically under the control of an organization. The data center 118 may include one or more enclosures of network computers, such as, an enclosure 120 and an enclosure 122.

The enclosure 120 and the enclosure 122 may be enclosures (e.g., racks, cabinets, or the like) of network computers and/or blade servers in the data center 118. In some embodiments, the enclosure 120 and the enclosure 122 may be arranged to include one or more network computers arranged to operate as operations management server computers, monitoring server computers (e.g., the operations management server computer 116, the monitoring server computer 114, or the like), storage computers, or the like, or combination thereof. Further, one or more cloud instances may be operative on one or more network computers included in the enclosure 120 and the enclosure 122.

The data center 118 may also include one or more public or private cloud networks. Accordingly, the data center 118 may comprise multiple physical network computers, interconnected by one or more networks, such as, networks similar to and/or the including network 111 and/or wireless network 110. The data center 118 may enable and/or provide one or more cloud instances (not shown). The number and composition of cloud instances may be vary depending on the demands of individual users, cloud network arrangement, operational loads, performance considerations, application needs, operational policy, or the like. In at least one of the various embodiments, the data center 118 may be arranged as a hybrid network that includes a combination of hardware resources, private cloud resources, public cloud resources, or the like.

As such, the operations management server computer 116 is not to be construed as being limited to a single environment, and other configurations, and architectures are also contemplated. The operations management server computer 116 may employ processes such as described below in conjunction with at least some of the figures discussed below to perform at least some of its actions.

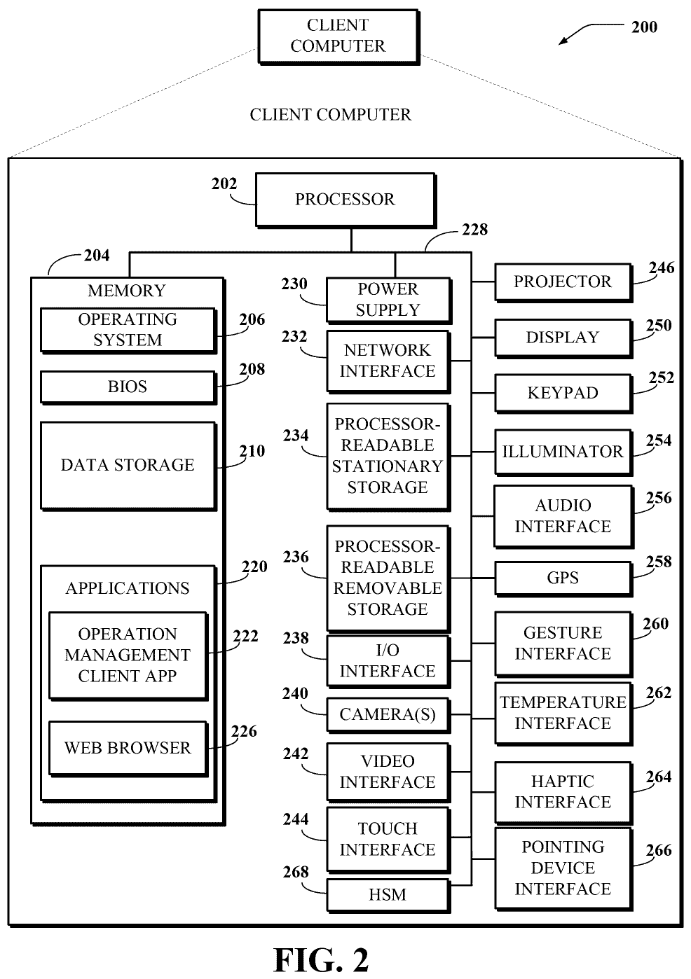

FIG. 2 shows one embodiment of a client computer 200. The client computer 200 may include more or less components than those shown in FIG. 2. The client computer 200 may represent, for example, at least one embodiment of mobile computers or client computers shown in FIG. 1.

The client computer 200 may include a processor 202 in communication with a memory 204 via a bus 228. The client computer 200 may also include a power supply 230, a network interface 232, an audio interface 256, a display 250, a keypad 252, an illuminator 254, a video interface 242, an input/output interface (i.e., an I/O interface 238), a haptic interface 264, a global positioning systems (GPS) receiver 258, an open-air gesture interface 260, a temperature interface 262, a camera 240, a projector 246, a pointing device interface 266, a processor-readable stationary storage device 234, and a non-transitory processor-readable removable storage device 236. The client computer 200 may optionally communicate with a base station (not shown), or directly with another computer. And in one embodiment, although not shown, a gyroscope may be employed within the client computer 200 to measuring or maintaining an orientation of the client computer 200.

The power supply 230 may provide power to the client computer 200. A rechargeable or non-rechargeable battery may be used to provide power. The power may also be provided by an external power source, such as an AC adapter or a powered docking cradle that supplements or recharges the battery.

The network interface 232 includes circuitry for coupling the client computer 200 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. The network interface 232 is sometimes known as a transceiver, transceiving device, or network interface card (NIC).

The audio interface 256 may be arranged to produce and receive audio signals such as the sound of a human voice. For example, the audio interface 256 may be coupled to a speaker and microphone (not shown) to enable telecommunication with others or generate an audio acknowledgement for some action. A microphone in the audio interface 256 can also be used for input to or control of the client computer 200, e.g., using voice recognition, detecting touch based on sound, and the like.

The display 250 may be a liquid crystal display (LCD), gas plasma, electronic ink, light emitting diode (LED), Organic LED (OLED) or any other type of light reflective or light transmissive display that can be used with a computer. The display 250 may also include a touch interface 244 arranged to receive input from an object such as a stylus or a digit from a human hand, and may use resistive, capacitive, surface acoustic wave (SAW), infrared, radar, or other technologies to sense touch or gestures.

The projector 246 may be a remote handheld projector or an integrated projector that is capable of projecting an image on a remote wall or any other reflective object such as a remote screen.

The video interface 242 may be arranged to capture video images, such as a still photo, a video segment, an infrared video, or the like. For example, the video interface 242 may be coupled to a digital video camera, a web-camera, or the like. The video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

The keypad 252 may comprise any input device arranged to receive input from a user. For example, the keypad 252 may include a push button numeric dial, or a keyboard. The keypad 252 may also include command buttons that are associated with selecting and sending images.

The illuminator 254 may provide a status indication or provide light. The illuminator 254 may remain active for specific periods of time or in response to event messages. For example, when the illuminator 254 is active, it may backlight the buttons on the keypad 252 and stay on while the client computer is powered. Also, the illuminator 254 may backlight these buttons in various patterns when particular actions are performed, such as dialing another client computer. The illuminator 254 may also cause light sources positioned within a transparent or translucent case of the client computer to illuminate in response to actions.

Further, the client computer 200 may also comprise a hardware security module (i.e., an HSM 268) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 268 may be a stand-alone computer, in other cases, the HSM 268 may be arranged as a hardware card that may be added to a client computer.

The I/O 238 can be used for communicating with external peripheral devices or other computers such as other client computers and network computers. The peripheral devices may include an audio headset, display screen glasses, remote speaker system, remote speaker and microphone system, and the like. The I/O interface 238 can utilize one or more technologies, such as Universal Serial Bus (USB), Infrared, WiFi, WiMax, Bluetooth™, and the like.

The I/O interface 238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the client computer 200.

The haptic interface 264 may be arranged to provide tactile feedback to a user of the client computer. For example, the haptic interface 264 may be employed to vibrate the client computer 200 in a particular way when another user of a computer is calling. The temperature interface 262 may be used to provide a temperature measurement input or a temperature changing output to a user of the client computer 200. The open-air gesture interface 260 may sense physical gestures of a user of the client computer 200, for example, by using single or stereo video cameras, radar, a gyroscopic sensor inside a computer held or worn by the user, or the like. The camera 240 may be used to track physical eye movements of a user of the client computer 200.

The GPS transceiver 258 can determine the physical coordinates of the client computer 200 on the surface of the earth, which typically outputs a location as latitude and longitude values. The GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the client computer 200 on the surface of the earth. It is understood that under different conditions, the GPS transceiver 258 can determine a physical location for the client computer 200. In at least one embodiment, however, the client computer 200 may, through other components, provide other information that may be employed to determine a physical location of the client computer, including for example, a Media Access Control (MAC) address, IP address, and the like.

Human interface components can be peripheral devices that are physically separate from the client computer 200, allowing for remote input or output to the client computer 200. For example, information routed as described here through human interface components such as the display 250 or the keypad 252 can instead be routed through the network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Bluetooth LE, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include a web browser application 226 that is configured to receive and to send web pages, web-based messages, graphics, text, multimedia, and the like. The client computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

The memory 204 may include RAM, ROM, or other types of memory. The memory 204 illustrates an example of computer-readable storage media (devices) for storage of information such as computer-readable instructions, data structures, program modules or other data. The memory 204 may store a BIOS 208 for controlling low-level operation of the client computer 200. The memory may also store an operating system 206 for controlling the operation of the client computer 200. It will be appreciated that this component may include a general-purpose operating system such as a version of UNIX, or LINUX™, or a specialized client computer communication operating system such as Windows Phone™, or IOS® operating system. The operating system may include, or interface with, a Java virtual machine module that enables control of hardware components or operating system operations via Java application programs.

The memory 204 may further include one or more data storage 210, which can be utilized by the client computer 200 to store, among other things, the applications 220 or other data. For example, the data storage 210 may also be employed to store information that describes various capabilities of the client computer 200. The information may then be provided to another device or computer based on any of a variety of methods, including being sent as part of a header during a communication, sent upon request, or the like. The data storage 210 may also be employed to store social networking information including address books, buddy lists, aliases, user profile information, or the like. The data storage 210 may further include program code, data, algorithms, and the like, for use by a processor, such as the processor 202 to execute and perform actions. In one embodiment, at least some of the data storage 210 might also be stored on another component of the client computer 200, including, but not limited to, the non-transitory processor-readable removable storage device 236, the processor-readable stationary storage device 234, or external to the client computer.

The applications 220 may include computer executable instructions which, when executed by the client computer 200, transmit, receive, or otherwise process instructions and data. The applications 220 may include, for example, an operations management client application 222. In at least one of the various embodiments, the operations management client application 222 may be used to exchange communications to and from the operations management server computer 116 of FIG. 1, the monitoring server computer 114 of FIG. 1, the application server computer 112 of FIG. 1, or the like. Exchanged communications may include, but are not limited to, queries, searches, messages, notification messages, events, alerts, performance metrics, log data, API calls, or the like, combination thereof.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

Additionally, in one or more embodiments (not shown in the figures), the client computer 200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the client computer 200 may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

FIG. 3 shows one embodiment of network computer 300 that may at least partially implement one of the various embodiments. The network computer 300 may include more or less components than those shown in FIG. 3. The network computer 300 may represent, for example, one embodiment of at least one EMB, such as the operations management server computer 116 of FIG. 1, the monitoring server computer 114 of FIG. 1, or an application server computer 112 of FIG. 1. Further, in some embodiments, the network computer 300 may represent one or more network computers included in a data center, such as, the data center 118, the enclosure 120, the enclosure 122, or the like.

As shown in the FIG. 3, the network computer 300 includes a processor 302 in communication with a memory 304 via a bus 328. The network computer 300 also includes a power supply 330, a network interface 332, an audio interface 356, a display 350, a keyboard 352, an input/output interface (i.e., an I/O interface 338), a processor-readable stationary storage device 334, and a processor-readable removable storage device 336. The power supply 330 provides power to the network computer 300.

The network interface 332 includes circuitry for coupling the network computer 300 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. The network interface 332 is sometimes known as a transceiver, transceiving device, or network interface card (NIC). The network computer 300 may optionally communicate with a base station (not shown), or directly with another computer.

The audio interface 356 is arranged to produce and receive audio signals such as the sound of a human voice. For example, the audio interface 356 may be coupled to a speaker and microphone (not shown) to enable telecommunication with others or generate an audio acknowledgement for some action. A microphone in the audio interface 356 can also be used for input to or control of the network computer 300, for example, using voice recognition.

The display 350 may be a liquid crystal display (LCD), gas plasma, electronic ink, light emitting diode (LED), Organic LED (OLED) or any other type of light reflective or light transmissive display that can be used with a computer. The display 350 may be a handheld projector or pico projector capable of projecting an image on a wall or other object.

The network computer 300 may also comprise the I/O interface 338 for communicating with external devices or computers not shown in FIG. 3. The I/O interface 338 can utilize one or more wired or wireless communication technologies, such as USB™ Firewire™, WiFi, WiMax, Thunderbolt™, Infrared, Bluetooth™, Zigbee™, serial port, parallel port, and the like.

Also, the I/O interface 338 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to the network computer 300. Human interface components can be physically separate from network computer 300, allowing for remote input or output to the network computer 300. For example, information routed as described here through human interface components such as the display 350 or the keyboard 352 can instead be routed through the network interface 332 to appropriate human interface components located elsewhere on the network. Human interface components include any component that allows the computer to take input from, or send output to, a human user of a computer. Accordingly, pointing devices such as mice, styluses, track balls, or the like, may communicate through a pointing device interface 358 to receive user input.

A GPS transceiver 340 can determine the physical coordinates of network computer 300 on the surface of the Earth, which typically outputs a location as latitude and longitude values. The GPS transceiver 340 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of the network computer 300 on the surface of the Earth. It is understood that under different conditions, the GPS transceiver 340 can determine a physical location for the network computer 300. In at least one embodiment, however, the network computer 300 may, through other components, provide other information that may be employed to determine a physical location of the client computer, including for example, a Media Access Control (MAC) address, IP address, and the like.

The memory 304 may include Random Access Memory (RAM), Read-Only Memory (ROM), or other types of memory. The memory 304 illustrates an example of computer-readable storage media (devices) for storage of information such as computer-readable instructions, data structures, program modules or other data. The memory 304 stores a basic input/output system (i.e., a BIOS 308) for controlling low-level operation of the network computer 300. The memory also stores an operating system 306 for controlling the operation of the network computer 300. It will be appreciated that this component may include a general-purpose operating system such as a version of UNIX, or LINUX™, or a specialized operating system such as Microsoft Corporation's Windows® operating system, or the Apple Corporation's IOS® operating system. The operating system may include, or interface with a Java virtual machine module that enables control of hardware components or operating system operations via Java application programs. Likewise, other runtime environments may be included.

The memory 304 may further include a data storage 310, which can be utilized by the network computer 300 to store, among other things, applications 320 or other data. For example, the data storage 310 may also be employed to store information that describes various capabilities of the network computer 300. The information may then be provided to another device or computer based on any of a variety of methods, including being sent as part of a header during a communication, sent upon request, or the like. The data storage 310 may also be employed to store social networking information including address books, buddy lists, aliases, user profile information, or the like. The data storage 310 may further include program code, instructions, data, algorithms, and the like, for use by a processor, such as the processor 302 to execute and perform actions such as those actions described below. In one embodiment, at least some of the data storage 310 might also be stored on another component of the network computer 300, including, but not limited to, the non-transitory media inside processor-readable removable storage device 336, the processor-readable stationary storage device 334, or any other computer-readable storage device within the network computer 300 or external to network computer 300. The data storage 310 may include, for example, models 312, operations metrics 314, events 316, or the like.

The applications 320 may include computer executable instructions which, when executed by the network computer 300, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. The applications 320 may be or include executable instructions, which can be loaded or copied, in whole or in part, from non-volatile memory to volatile memory to be executed by the processor 302. For example, the applications 320 can include instructions for performing some or all of the techniques of this disclosure. For example, the applications 320 can include software, tools, instructions or the like for grouping groupable objects. In at least one of the various embodiments, one or more of the applications may be implemented as modules or components of another application. Further, in at least one of the various embodiments, applications may be implemented as operating system extensions, modules, plugins, or the like.

Furthermore, in at least one of the various embodiments, at least some of the applications 320 may be operative in a cloud-based computing environment. In at least one of the various embodiments, these applications, and others, that include the management platform may be executing within virtual machines or virtual servers that may be managed in a cloud-based based computing environment. In at least one of the various embodiments, in this context the applications may flow from one physical network computer within the cloud-based environment to another depending on performance and scaling considerations automatically managed by the cloud computing environment. Likewise, in at least one of the various embodiments, virtual machines or virtual servers dedicated to at least some of the applications 320 may be provisioned and de-commissioned automatically.

In at least one of the various embodiments, the applications may be arranged to employ geo-location information to select one or more localization features, such as, time zones, languages, currencies, calendar formatting, or the like. Localization features may be used in user-interfaces and well as internal processes or databases. Further, in some embodiments, localization features may include information regarding culturally significant events or customs (e.g., local holidays, political events, or the like) In at least one of the various embodiments, geo-location information used for selecting localization information may be provided by the GPS transceiver 340. Also, in some embodiments, geolocation information may include information providing using one or more geolocation protocol over the networks, such as, the wireless network 108 or the network 111.

Also, in at least one of the various embodiments, at least some of the applications 320, may be located in virtual servers running in a cloud-based computing environment rather than being tied to one or more specific physical network computers.

Further, the network computer 300 may also comprise hardware security module (i.e., an HSM 360) for providing additional tamper resistant safeguards for generating, storing or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, the HSM 360 may be a stand-alone network computer, in other cases, the HSM 360 may be arranged as a hardware card that may be installed in a network computer.

Additionally, in one or more embodiments (not shown in the figures), the network computer 300 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include a hardware microcontroller instead of a CPU. In at least one embodiment, the microcontroller may directly execute its own embedded logic to perform actions and access its own internal memory and its own external Input and Output Interfaces (e.g., hardware pins or wireless transceivers) to perform actions, such as System On a Chip (SOC), or the like.

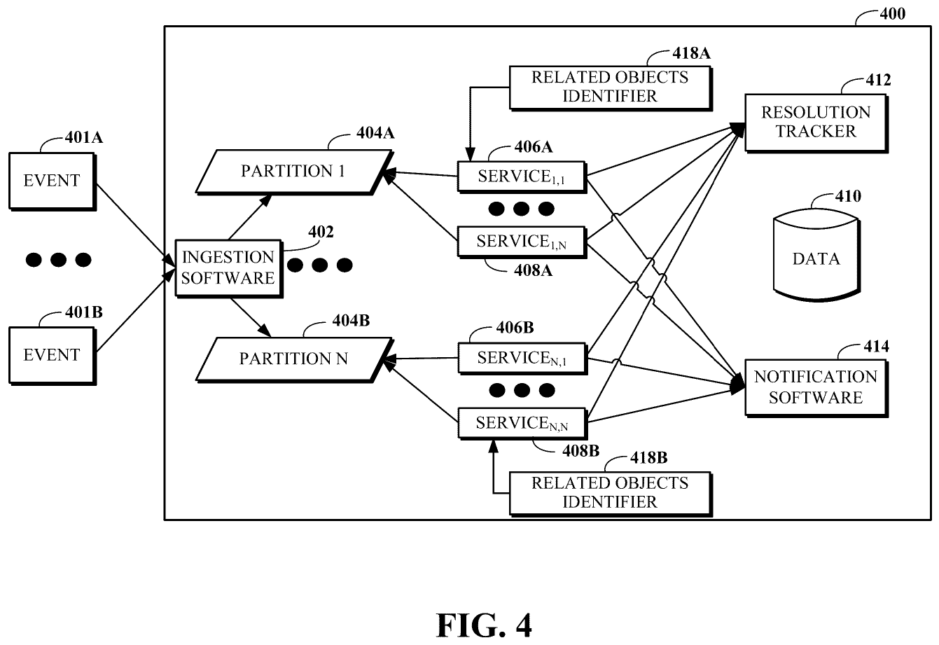

FIG. 4 illustrates a logical architecture of a system 400 for grouping groupable objects. Given a groupable object, the system 400 can identify a group to add the groupable object to. The system 400 can be an EMB and can be used to determine whether a newly received or created groupable object is related to an existing groupable object. If the newly received or created groupable object is determined to be related to an existing groupable object, then the system 400 groups the newly received or created groupable with the existing groupable object so that downstream objects need not be created for the newly received or created groupable. As already mentioned, a groupable object can be an event, an alert, or some other object of or created in the system 400.

Metadata (e.g., an attribute or a field or a combination thereof) of a groupable object can be used to determine whether the groupable object is related to another groupable object. The metadata can include a title (e.g., a short description), or other attributes of the groupable object. In an example, data associated with another object that may be related to the groupable object can be used to determine whether the groupable object is related to another. To illustrate, data associated with an event from which an alert is triggered, or data associated with an incident that is triggered from another alert, may be used to determine whether the alert is related to another alert; or data associated with an event or an alert from which an incident is triggered may be used to determine whether the incident is related to another incident.

In at least one of the various embodiments, a system for identifying related groupable objects may include various components. In this example, the system 400 includes an ingestion software 402, one or more partitions 404A-404B, one or more services 406A-406B and 408A-408B, a data store 410, a resolution tracker 412, a notification software 414, and related-objects identifier software 418A-418B.

One or more systems, such as monitoring systems, of one or more organizations may be configured to transmit events to the system 400 for processing. The system 400 may provide several services. A service may, for example, process an event and determine whether a downstream object (e.g., an incident) is to be triggered. As mentioned above, a received event may trigger an alert, which may trigger an incident, which in turn may cause notifications to be transmitted to responders.

A received event from an organization may include an indication of one or more services that are to operate on (e.g., process, etc.) the event. The indication of the service is referred to herein as a routing key. A routing key may be unique to a managed organization. As such, two events that are received from two different managed organizations for processing by a same service would include two different routing keys. A routing key may be unique to the service that is to receive and process an event. As such, two events associated with two different routing keys and received from the same managed organization for processing may be directed to (e.g., processed by) different services.

The ingestion software 402 may be configured to receive or obtain different types of events provided by various sources, here represented by events 401A, 401B. The ingestion software 402 may be configured to accept or reject received events. In an example, events may be rejected when events are received at a rate that is higher than a configured event-acceptance rate. If the ingestion software 402 accepts an event, the ingestion software 402 may place the event in a partition (such as one of the partitions 404A, 404B) for further processing. If an event is rejected, the event is not placed in a partition for further processing. The ingestion software may notify the sender of the event of whether the event was accepted or rejected. Grouping events into partitions can be used to enable parallel processing and/or scaling of the system 400 so that the system 400 can handle (e.g., process, etc.) more and more events and/or more and more organizations (e.g., additional events from additional organizations).

The ingestion software 402 may be arranged to receive the various events and perform various actions, including, filtering, reformatting, information extraction, data normalizing, or the like, or combination thereof, to enable the events to be stored (e.g., queued, etc.) and further processed. In at least one of the various embodiments, the ingestion software 402 may be arranged to normalize incoming events into a unified common event format. Accordingly, in some embodiments, the ingestion software 402 may be arranged to employ configuration information, including, rules, maps, dictionaries, or the like, or combination thereof, to normalize the fields and values of incoming events to the common event format. The ingestion software 402 may assign (e.g., associate, etc.) an ingested timestamp with an accepted event.

In at least one of the various embodiments, an event may be stored in a partition, such as one of the partition 404A or the partition 404B. A partition can be, or can be thought of, as a queue (e.g., a first-in-first-out queue) of events. FIG. 4 is shown as including two partitions (i.e., the partitions 404A and 404B). However, the disclosure is not so limited and the system 400 can include one or more than two partitions.

In an example, different services of the system 400 may be configured to operate on events of the different partitions. In an example, the same services (e.g., identical logic) may be configured to operate on the accepted events in different partitions. To illustrate, in FIG. 4, the services 406A and 408A process the events of the partition 404A, and the services 406B and 408B process the events of partition the 404B, where the service 406A and the service 406B execute the same logic (e.g., perform the same operations) of a first service but on different physical or virtual servers; and the service 408A and the service 408B execute the same logic of a second service but on different physical or virtual servers. In an example, different types of events may be routed to different partitions. As such, each of the services 406A-406B and 408A-408B may perform different logic as appropriate for the events processed by the service.

An (e.g., each) event, may also be associated with one or more services that may be responsible for processing the events. As such, an event can be said to be addressed or targeted to the one or more services that are to process the event. As mentioned above, an event can include or can be associated with a routing key that indicates the one or more services that are to receive the event for processing.

Events may be variously formatted messages that reflect the occurrence of events or incidents that have occurred in the computing systems or infrastructures of one or more managed organizations. Such events may include facts regarding system errors, warning, failure reports, customer service requests, status messages, or the like. One or more external services, at least some of which may be monitoring services, may collect events and provide the events to the system 400. Events as described above may be comprised of, or transmitted to the system 400 via, SMS messages, HTTP requests/posts, API calls, log file entries, trouble tickets, emails, or the like. An event may include associated metadata, such as, a title (or subject), a source, a creation time stamp, a status indicator, a region, more information, fewer information, other information, or a combination thereof, that may be tracked. In an example, the event data may be received as a structured data, which may be formatted using JavaScript Object Notation (JSON), XML, or some other structured format. The metadata associated with an event is not limited in any way. The metadata included in or associated with an event can be whatever the sender of the event deems required.

In at least one of the various embodiments, a data store 410 may be arranged to store performance metrics, configuration information, or the like, for the system 400. In an example, the data store 410 may be implemented as one or more relational database management systems, one or more object databases, one or more XML databases, one or more operating system files, one or more unstructured data databases, one or more synchronous or asynchronous event or data buses that may use stream processing, one or more other suitable non-transient storage mechanisms, or a combination thereof.

Data related to events, alerts, incidents, notifications, other types of objects, or a combination thereof may be stored in the data store 410. For example, the data store 410 can include data related to resolved and unresolved alerts. For example, the data store 410 can include data identifying whether alerts are or are not acknowledged. For example, with respect to a resolved alert, the data store 410 can include information regarding the resolving entity that resolved the alert (and/or, equivalently, the resolving entity of the event that triggered the alert), the duration that the alert was active until it was resolved, other information, or a combination thereof. The resolving entity can be a responder (e.g., a human). The resolving entity can be an integration (e.g., automated system), which can indicate that the alert was auto-resolved. That the alert is auto-resolved can mean that the system 400 received, such as from the integration, an event indicating that a previous event, which triggered the alert, is resolved. The integration may be a monitoring system.

The data store 410 can be used to store template data that can be used by a template selector (such as a template selector of the related-objects identifier software 418A or the related-objects identifier software 418B) to identify related objects. The template data can be used to identify (e.g., select, choose, infer, determine, etc.) a template for a groupable object. The data store 410 can be used to store an association between the groupable object and the identified template. In an example, an identifier of the identified template can be stored as metadata of the groupable object. As such, the data store 410 can include historical data of groupable objects and corresponding templates.

The data store 410 can be used to store groups of groupable objects. The data store 410 can include associations between a group and the groupable objects included in the group. For example, a unique identifier can be associated with a group of groupable objects in the data store 410; and the unique identifier may be associated with each of the groupable objects of the group.

In at least one of the various embodiments, the resolution tracker 412 may be arranged to monitor the details regarding how events, alerts, incidents, other objects received, created, managed by the system 400, or a combination thereof are resolved. In some embodiments, this may include tracking incident and/or alert life-cycle metrics related to the events (e.g., creation time, acknowledgement time(s), resolution time, processing time), the resources that are/were responsible for resolving the events, the resources (e.g., the responder or the automated process) that resolved alerts, and so on. The resolution tracker 412 can receive data from the different services that process events, alerts, or incidents. Receiving data from a service by the resolution tracker 412 encompasses receiving data directly from the service and/or accessing (e.g., polling for, querying for, asynchronously being notified of, etc.) data generated (e.g., set, assigned, calculated by, stored, etc.) by the service. The resolution tracker can receive (e.g., query for, read, etc.) data from the data store 410. The resolution tracker can write (e.g., update, etc.) data in the data store 410.

While FIG. 4 is shown as including one resolution tracker 412, the disclosure herein is not so limited and the system 400 can include more than one resolution tracker. In an example, different resolution trackers may be configured to receive data from services of one or more partitions. In an example, each partition may have associated with one resolution tracker. Other configurations or mappings between partitions, services, and resolution trackers are possible.

The notification software 414 may be arranged to generate notification messages for at least some of the accepted events. The notification messages may be transmitted to responders (e.g., responsible users, teams) or automated systems. The notification software 414 may select a messaging provider that may be used to deliver a notification message to the responsible resource. The notification software 414 may determine which resource is responsible for handling the event message and may generate one or more notification messages and determine particular message providers to use to send the notification message.

In at least one of the various embodiments, a scheduler (not shown) may determine which responder is responsible for handling an incident based on at least an on-call schedule and/or the content of the incident. The notification software 414 may generate one or more notification messages and determine a particular message providers to use to send the notification message. Accordingly, the selected message providers may transmit (e.g., communicate, etc.) the notification message to the responder. Transmitting a notification to a responder, as used herein, and unless the context indicates otherwise, encompasses transmitting the notification to a team or a group. In some embodiments, the message providers may generate an acknowledgment message that may be provided to system 400 indicating a delivery status of the notification message (e.g., successful or failed delivery).

In at least one of the various embodiments, the notification software 414 may determine the message provider based on a variety of considerations, such as, geography, reliability, quality-of-service, user/customer preference, type of notification message (e.g., SMS or Push Notification, or the like), cost of delivery, or the like, or combination thereof. In at least one of the various embodiments, various performance characteristics of each message provider may be stored and/or associated with a corresponding provider performance profile. Provider performance profiles may be arranged to represent the various metrics that may be measured for a provider. Also, provider profiles may include preference values and/or weight values that may be configured rather than measured,

In at least one of the various embodiments, the system 400 may include various user-interfaces or configuration information (not shown) that enable organizations to establish how events should be resolved. Accordingly, an organization may define, rules, conditions, priority levels, notification rules, escalation rules, routing keys, or the like, or combination thereof, that may be associated with different types of events. For example, some events (e.g., of the frequent type) may be informational rather than associated with a critical failure. Accordingly, an organization may establish different rules or other handling mechanics for the different types of events. For example, in some embodiments, critical events (e.g., rare or novel events) may require immediate (e.g., within the target lag time) notification of a response user to resolve the underlying cause of the event. In other cases, the events may simply be recorded for future analysis.

In an example, one or more of the user interfaces may be used to associate runbooks with certain types of groupable objects. A runbook can include a set of actions that can implement or encapsulate a standard operating procedure for responding to (e.g., remediating, etc.) events of certain types. Runbooks can reduce toil. Toil can be defined as the manual or semi-manual performance of repetitive tasks. Toil can reduce the productivity of responders (e.g., operations engineers, developers, quality assurance engineers, business analysts, project managers, and the like) and prevents them from performing other value-adding work. In an example, a runbook may be associated with a template. As such, if a groupable object matches the template, then the tasks of the runbook can be performed (e.g., executed, orchestrated, etc.) according to the order, rules, and/or workflow specified in the runbook. In another example, the runbook can be associated with a type. As such, if a groupable object is identified as being of a certain type, then the tasks of the runbook associated with the certain type can be performed. A runbook can be assembled from predefined actions, custom actions, other types of actions, or a combination thereof.

In an example, one or more of the user interfaces may be used by responders to obtain information regarding groupable objects and/or groups of groupable objects. For example, a responder can use one of the user interfaces to obtain information regarding incidents assigned to or acknowledged by the responder. A user interface can be used to obtain information about an incident including the events (i.e., the group of events) associated with the incident. In an example, the responder can use the user interface to obtain information from the system 400 regarding the reason(s) a particular event was added to the group of events.

At least one of the services 406A-406B and 408A-408B may be configured to trigger alerts. A service can also trigger an incident from an alert, which in turn can cause notifications to be transmitted to one or more responders.

The system 400 is shown as including two related objects identifiers (i.e., the related-objects identifier software 418A-418B) where the related-objects identifier software 418A, 418B are associated with the services 406A, 408B, respectively. However, other arrangements (e.g., configurations, etc.) are possible and the disclosure is not limited to the configuration shown in FIG. 4. For example, the system 400 may include one or more than two related objects identifiers. For example, each of the services of the system 400 can be associated with its respective related-objects identifier. For example, more than one service may be associated with a respective related-objects identifier. For example, a respective related-objects identifier software can be available for, or associated with one or more routing keys or one or more managed organizations.

That a related-objects identifier software is associated with a service can mean or include that the service may include the related-objects identifier software (e.g., includes the logic, instructions, tools, etc. performed by the related objects identifier). That a related-objects identifier software is associated with a service can mean that the related-objects identifier software can receive or access a groupable object (e.g., an alert) created by the service and may determine to group the groupable object with other objects or to create a new downstream object (e.g., an incident) for the groupable object. That a related-objects identifier software is associated with a service can mean that, given a groupable object, the related-objects identifier software may receive an identifier of a group to which the groupable object is to be added, if any.

The related-objects identifier software can be associated with a service in other ways. For example, alternatively or additionally, a related-objects identifier software may be configured to asynchronously receive notifications when groupable objects are created, such as, for example, when new groupable objects are stored in the data store 410, when a service instantiates (e.g., creates, write to memory, etc.) a groupable object, or the like. In a typical configuration, regardless of the association of services to related objects identifiers, grouping of groupable objects does not cross organizational boundaries. That is, a groupable object that is associated with one organization would not be grouped with groupable objects of other organizations.

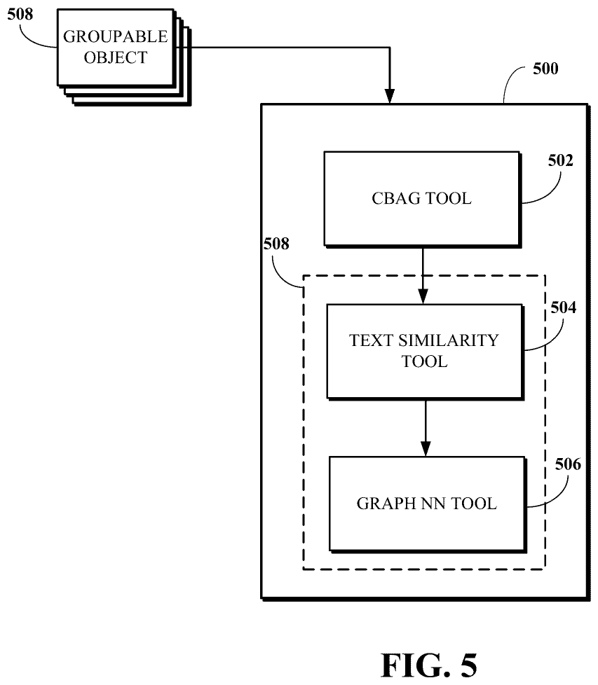

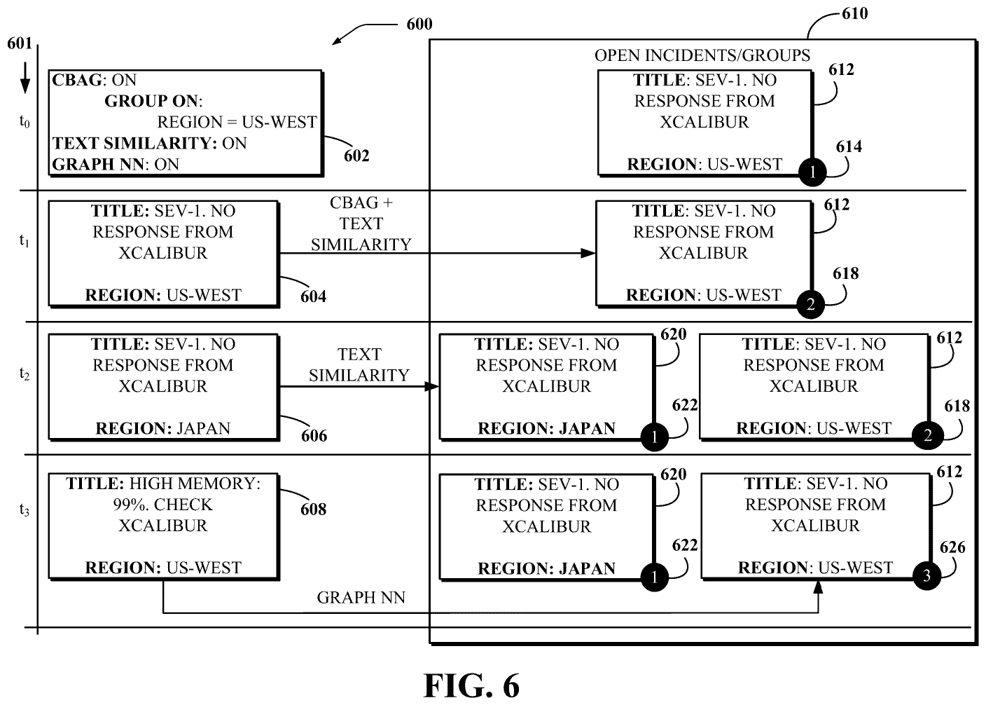

FIG. 5 is a block diagram of example functionality of a related-objects identifier software 500. The related-objects identifier software 500 can be one of the related-objects identifier software 418A or 418B of FIG. 4. The related-objects identifier software 500 includes tools, such as programs, subprograms, functions, routines, subroutines, operations, executable instructions, machine-learning models, and/or the like for, inter alia and as further described below, identifying whether a groupable object is related to another groupable object that is representative of a group of groupable objects, and if so, to associate the groupable object with the group. The related-objects identifier software 500 is further described by reference to FIG. 6.

At least some of the tools of the related-objects identifier software 500 can be implemented as respective software programs that may be executed by one or more network computer, such as the network computer 300 of FIG. 3. A software program can include machine-readable instructions that may be stored in a memory such as the processor-readable stationary storage device 334 or the processor-readable removable storage device 336 of FIG. 3, and that, when executed by a processor, such as processor 302, may cause the network computer to perform the instructions of the software program.

As shown, the related-objects identifier software 500 includes a CBAG tool 502, a text similarity tool 504, and a graph-based neural network 506. In some implementations, the related-objects identifier software 500 can include more or fewer tools. For example, some implementations may include only the graph-based neural network 506; and some implementations may only include the graph-based neural network 506 and one of the CBAG tool 502 or the text similarity tool 504. In some implementations, some of the tools may be combined, some of the tools may be split into more tools, or a combination thereof.

The related-objects identifier software 500 receives groupable objects 510 (e.g., alerts) and adds each of the groupable objects to an existing group or creates a new group for the groupable object. The CBAG tool 502, the text similarity tool 504, and the graph-based neural network 506 are shown as being connected in series. That is, a groupable object may be first examined by the CBAG tool 502 to identify is subset of groupable objects that the groupable object can be grouped with, then by the text similarity tool 504, and/or then by the graph-based neural network 506 to determine which group of groupable object to group the object with.

In an example, a groupable object may be examined (i.e., processed) by the CBAG tool 502, followed by the text similarity tool 504. If the text similarity tool 504 determines that the groupable object is not similar to any other groupable object, then the groupable object is examined by the graph-based neural network 506; otherwise, if the text similarity tool 504 determines that the groupable object is similar to other groupable object, then the groupable object is not examined by the graph-based neural network 506. Such arrangement can result in conservative groupings and generates groupings that may be the least unexpected, as further described herein.

The text similarity tool 504 tends to generate relatively explainable and high precision groupings. That is, if the text similarity tool 504 determines that two alerts are related (e.g., similar), the determination is usually correct and reliable. On the other hand, while the graph-based neural network 506 has lower precision, it can be capable of discovering non-obvious relations between groupable objects and, as such, has a theoretically higher performance than the text similarity tool 504. However, the graph-based neural network 506 may tend to be aggressive in identifying groupings. By arranging the tools of the related-objects identifier software 500 so that the text similarity tool 504 examines a groupable object before the graph-based neural network 506, the related-objects identifier software 500 can balance grouping precision and grouping recall. As such, in an example, only when text similarity tool 504 determines (based on textual similarities) that a groupable object cannot be added to any other group that the graph-based neural network 506 will be used identify a group of groupable objects that to add the groupable object to.

The CBAG tool 502 can be configured with CBAG rules for grouping groupable object. In an example, a user can configure the CBAG rules using a web browser, such as the web browser application 226 of FIG. 2, As mentioned above, a groupable object can include metadata (i.e., fields), which can be used to set the CBAG rules. In addition to a title, a groupable object may include fields that can be relevant in grouping. For example, as mentioned above, event data may be received in a structured packet (e.g., a JSON packet) that may be transferred (e.g., copied) to a triggered alert. The metadata (i.e., fields) can be used to configure the CBAG tool 502 with CBAG rules. CBAG rules can include conditions (e.g., criteria) related to one or more fields. The conditions can include regular expression patterns, logic operators, Boolean operators, set operators, and arithmetic operators, to name a few.

CBAG rules can be used to increase the precision of groupings to meet requirements of a particular organization (as specified or embodied in the CBAG rules). A user (e.g., an authorized user of an organization) can configure the CBAG tool 502 with rules that direct the CBAG tool 502 to group based on the particular rules. As further described herein, the CBAG rules can be used to group groupable objects (e.g., alerts) based on the field values of the groupable objects (e.g., alerts). However, setting CBAG rules may be impractical and may not scale. For example, it may not be reasonable to expect users to configure and manager 10s (let alone 100s or 1000s) of CBAG rules.

The text similarity tool 504 identifies whether two groupable objects are similar based on textual strings associated therewith. For example, a textual string associated with an alert can be or include one or more metadata of the alert. In an example, the textual string can be a title (e.g., subject or one such similar metadata) of the alert. In another example, the textual string can be composed from more than two metadata strings associated with the alert. The use of the text similarity tool 504 is premised on the assumption that similar alert text refers to similar infrastructure issues (such as similar infrastructure issues across services).

The text similarity tool 504 can use any number of text matching techniques to determine whether two alerts are textually similar. For example, techniques that measure edit distances between textual strings can be used. As is known, edit distance can be a measure of similarity (or, dissimilarity) between the two text strings. The edit distance can be obtained, for example, by counting a minimum number of operations required to transform a first string into the second string. Any number of techniques or combination of techniques can be used to obtain the edit distance between two text strings, including, but not limited to, calculating a hamming distance, a Jaccard similarity score, a Jaro-Winkler distance, a Levenshtine distance, a NeedlemanWunch distance, a phonetic distance, and/or some other technique. In an example, the Jaro-Winkler distance can be used.

In an example, the text similarity tool 504 can normalize groupable object (e.g., alert) titles to obtain normalized titles. The normalized titles can be tokenized, cleaned, and vectorized. Tokenizing can split the normalized title into words and/or groups of groups (collectively, n-grams), typically using special characters and/or white spaces to identify the n-grams. Cleaning (e.g., normalizing) the words of the normalized title, which may be performed before or after the tokenizing, can include zero or more of stemming, removing stop words (e.g., very common words that do not add value to the title) from the word vector, other steps, or a combination thereof. Vectorizing can mean converting the n-grams into respective vector representations of numbers based on all the words identified in the training dataset (i.e., all words of the normalized titles used for training the ML, model). Any number of techniques can be used to vectorize the word vector, such as count vectorization, n-gram selection, term frequency-inverse document frequency (TFIDF), or other techniques. Cosine similarities or cosine similarity is a metric used to measure the similarity between features of two items, documents, or the like, represented as feature vectors. The technique of cosine similarities measures the cosine of an angle between two vectors of data projected in multi-dimensional space. This measurement allows a measure the similarity of a document of any type, such as of the alerts disclosed herein.

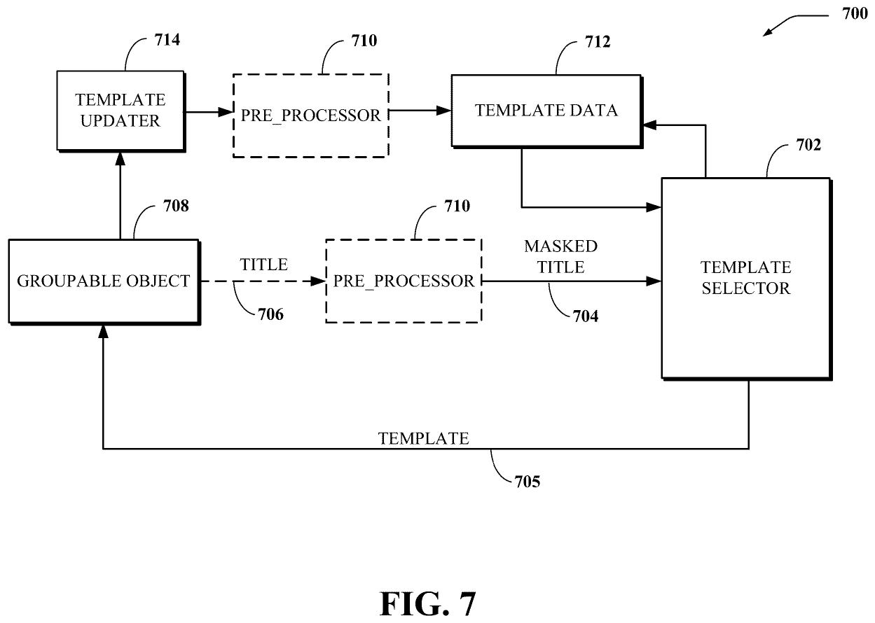

In an example, the text similarity tool 504 can determine that two alerts are similar if a text template identified for the first alert is the same as the text template identified of the second alert. The text similarity tool 504 may include a template selector that receives an alert (or a string associated with an alert) and obtains a text template that the alert matches. Aspects of the text similarity tool 504 (and more specifically a template selector therein) is further described below with respect to FIGS. 7-9.

As mentioned, the text similarity tool 504 balances precision and recall in identifying related groupable objects. However, text similarity techniques may be considered to have theoretical limits. The assumption that similar texts are similar and different texts are different may not be correct. Stated another way, the assumption that two alerts with dissimilar texts are unrelated may not be accurate: dissimilar alert texts may not necessarily mean that the two alerts are unrelated or uncorrelated. That assumption may be true if, for example, event and alert texts were composed (e.g., drafted or coded) by a development team that follows the same set of coding standards and styles; however, it may not be true when disparate development teams compose events or alerts texts.

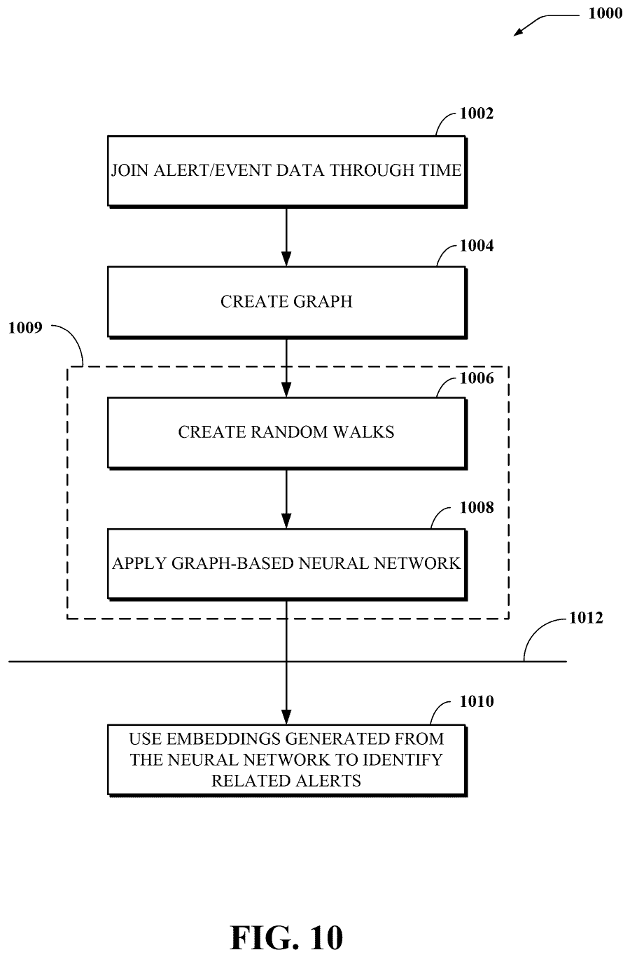

The graph-based neural network 506, which is a machine learning model that is trained, using historical correlations and co-occurrence of alerts, can be used to determine whether two alerts are related. The graph-based neural network 506 can be retrained as more alerts are received over time. Using language modeling techniques, the graph-based neural network 506 is trained to build a model that can obtain an embedding (e.g., one or vectors of numbers) from an alert and uses vector math to compare whether two alerts are related (e.g., semantically related or similar) or not. That is, the graph-based neural network can be used to obtain a numerical representation of an alert. The graph-based neural network 506 is further described with respect to FIGS. 10-12.

To illustrate an example of co-occurrence of alerts, assume that whenever there is a particular infrastructure issue, one alert (titled: “Lorem ipsum dolor sit amet, consectetur adipiscing elit”) is received and seems to be fairly frequently followed by a second received alert (titled: “Duis aute irure dolor in reprehenderit in voluptate velit esse cillum dolore eu fugiat nulla pariatur”). Clearly, such alerts cannot be said to be textually similar. When the first and the second alerts are processed by the graph-based neural network 506, they are embedded into respective vectors that will be very similar to each other (i.e., meet a similarity threshold). As such, when the graph-based neural network 506 calculates the similarity between the first and the second alerts, the graph-based neural network 506 will determine that they are very similar.

The graph-based neural network 506 increases recall of the related-objects identifier software 500 with respect to identifying related alerts. The graph-based neural network 506 can be used to overcome the above-described theoretical limitations of the text similarity tool 504. The graph-based neural network 506 tends to be a more aggressive and may over-group alerts as compared to the text similarity tool 504. Stated another way, the graph-based neural network 506 may tend to be over-aggressive in determining that alerts are related when, in fact, they should not be found to be related. The over-aggressiveness may result in inaccurate groupings. For this reason, the CBAG tool 502 and the text similarity tool 504 can temper this over-aggressiveness by being ahead of the graph-based neural network 506 in the series. As such, by combining the CBAG tool 502, the text similarity tool 504, and the graph-based neural network 506, as described herein, these tools can complete each other's strengths and weaknesses.

FIG. 6 illustrates examples 600 of identifying related groupable objects. That is, FIG. 6 includes examples of operations of the CBAG tool 502, the text similarity tool 504, and the graph-based neural network 506. FIG. 6 includes a timeline 601 according to which events 602-608 take place at different timesteps (i.e., t₀ to t₃). An open incidents/groups pool 610 reflects the result of processing the different events 602-608 by an objects identifier software, such as the related-objects identifier software 500 of FIG. 5. As further described herein, the open incidents/groups pool 610 shows the incidents triggered from received alerts and the number of alerts grouped under the incidents. As further described herein, an incident can be or can indicative or representative of a group of alerts.

At an initial timestep to, initial conditions are set for the remaining events 604-608. The event 602 indicates that the related-objects identifier software 500 is configured such that the CBAG tool 502, the text similarity tool 504, and the graph-based neural network 506 are each enabled (set to ON) so that a received event is processed, in series, through each of these tools. If a tool is disabled (e.g., set to OFF), then that tool does not contribute to the identification of related alerts for a received event and, as such, does not contribute to the grouping of the received event. As an additional initial condition, FIG. 6 illustrates that the open incidents/groups pool 610 includes an incident 612 that is currently open (i.e., not resolved).

The event 602 also includes a configured CBAG rule (GROUP ON: REGION=US-WEST), which is discussed below. As such, if a received event includes the field REGION, the CBAG tool 502 checks the value of that field to determine whether it matches the configured CBAG rule (i.e., whether the value is equal to “US-WEST”). The incident 612 is triggered from a first-of-its-kind alert (not shown). A counter 614 indicates that only one alert is currently grouped under the incident 612. It is noted that, for simplicity of explanation, FIG. 6 shows that an incident triggered from an alert may include the same data as the alert (e.g., same title and the same fields). However, that need not be the case and the disclosure herein is not so limited.

That a new alert is a “first-of-its-kind,” as used herein, can mean that the related-objects identifier software 500 did not determine that new, incoming alert is related to any other alert that is associated with a currently pending, unresolved incident; or that the related-objects identifier software 500 determined that, even though the new alert may be related to another alert that is associated with a currently pending unresolved incident, the new alert was not received within a timing criterion. In an example, the timing criterion can be that the new alert was not received within a time threshold (e.g., 15 minutes or 60 minutes) of a first-of-its-kind alert that triggered the currently pending, unresolved incident. In another example, the timing criterion can be that the new alert was not received within a time threshold (e.g., 15 minutes or 60 minutes) of a most recent alert that is related to the other alert.

At timestep t₁, an alert 604 is received by the related-objects identifier software 500. The CBAG tool 502 determines that the alert 604 matches the configured CBAG rule (i.e., REGION=US-WEST) and the text similarity tool 504 determines that the text of the alert 604 (i.e., “SEV-1. NO RESPONSE FROM XCALIBUR”) matches the incident 612. As such, the related-objects identifier software 500 groups the alert 604 under (i.e., with the other alerts of) the incident 612. A counter 618 now indicates that two alerts are grouped under the incident 612. Thus, as the title of the alert 604 is similar to the title of an existing active incident (i.e., the incident 612) as well as its region is the same as the region of the incident 612, the alert 604 will be grouped together with the existing open incident (i.e., the incident 612).

The related-objects identifier software 500 can determine whether a received alert matches an incident in any number of ways. In an example, the received alert is matched (i.e., compared to) the first-of-its-kind alert that triggered the incident. In an example, the received alert is matched to the last alert to be grouped under the incident. In an example, the received alert is matched to a randomly selected alert that is grouped under the incident. Other ways of determining whether a received alert matches an incident are possible.

At timestep t₂, an alert 606 is received by the related-objects identifier software 500. Since REGION (i.e., JAPAN) of the alert 606 does not match the configured CBAG rule (i.e., REGION=US-WEST), even though the text (i.e., “SEV-1. NO RESPONSE FROM XCALIBUR”) of the alert 606 exactly matches that of the incident 612, the alert 606 cannot be grouped under the incident 612. As such, a new incident (i.e., an incident 620) is triggered and the alert 606 is grouped under the incident 620. Thus, the alert 606 is a first-of-its-kind alert for the incident 620 (as illustrated by a counter 622).

At timestep t₃, an alert 608 is received by the related-objects identifier software 500. The alert 608 has a title of “HIGH MEMORY USAGE: 99%. CHECK XCALIBUR” and a region field that is equal to “US-WEST.” While the alert 608 matches the configured CBAG rule, the text similarity tool 504 determines that the title of the alert 608 does not match that of the open incident 612 (i.e., the incident having Region=US-WEST). However, the graph-based neural network 506, having been trained from historical data, determines that the alert 608 is related to one of the open alerts titled “SEV-1. NO RESPONSE FROM XCALIBUR”. As such, the related-objects identifier software 500 groups the alert 608 under the incident 612. A counter 626 indicates that three alerts are now grouped under the incident 612.

The CBAG tool 502 can be thought of as a file-cabinet selector (where the file cabinet includes drawers); and the text similarity tool 504 and the graph-based neural network 506 can be thought of as drawer selectors. In the example of FIG. 6, two file cabinet are illustrated: a first file cabinet corresponds to the US-WEST region and a “default” file cabinet where all alerts that do not explicitly match a configured CBAG rule are to be “filed.” The alert 606 is considered to be filed in such a “default” cabinet. The text similarity tool 504 and the graph-based neural network 506 then determine within a file cabinet which drawer (i.e., which subset of alerts) an incoming alert is to be grouped with, if any. If the incoming alert cannot be grouped with any other alert, then it is a first-of-its-kind and a new incident is triggered from the incoming alert.

FIG. 7 is a block diagram of an example 700 illustrating the operations of a template selector. The example 700 may be implemented in the system 400 of FIG. 4. The example 700 includes a template selector 702, which can be, can be included in, or can be implemented by, one of the related-objects identifier software 418A or 418B of FIG. 4 or the related-objects identifier software 500 of FIG. 5.

The template selector 702 receives a masked title 704, which may be a masked title of a groupable object 708, and outputs a corresponding template 705, if any. The template 705 is associated with the groupable object 708. The masked title can be obtained from (e.g., generated by, etc.) a pre-processor 710, which can receive the groupable object 708 or a title 706 of the groupable object and outputs the masked title 704. The masked title 704 can be associated with the groupable object 708. In some examples, the title 706 may not be pre-processed and the template selector 702 can identify the template 705 for the groupable object 708 based on the title 706 (instead of based on the masked title 704). In an example, the pre-processor 710 can be part of, or included in, the template selector 702. As such, the template selector 702 can receive the groupable object 708 (of a title therefor), pre-process the title to obtain the masked title and then obtain the template 705 based on the masked title.

Each groupable object can have an associated title. The title 706 of the groupable object 708 may be or may be derived from another object that may be associated with or related to the groupable object 708. While the description herein may use an attribute of a groupable object that may be named “title” and refers to a “masked title,” the disclosure is not so limited. Broadly, a title can be any attribute, a combination of attributes, or the like that may be associated with a groupable object and from which a corresponding masked string can be obtained.

For brevity, that the template selector 702 receives the groupable object 708 encompasses at least one or a combination of the following scenarios. That the template selector 702 receives the groupable object 708 can mean, in an implementation, that the template selector 702 receives the groupable object 708 itself. That the template selector 702 receives the groupable object 708 can mean, in an implementation, that the template selector 702 receives the masked title 704 of the groupable object 708. That the template selector 702 receives the groupable object 708 can mean, in an implementation, that the template selector 702 receives the title 706 of the groupable object 708. That the template selector 702 receives the groupable object 708 can mean, in an implementation, that the template selector 702 receives a title or a masked title of an object related to the groupable object 708.

The pre-processor 710 may apply any number of text processing (e.g., manipulation) rules to the title of the groupable object 708 to obtain the masked title. It is noted that the title is not itself changed as a result of the text processing rules. As such, stating that a rule X is applied to the title (such as the title of the groupable object), or any such similar statements, should be understood to mean that the rule X is applied to a copy of the title. The text processing rules are intended to remove sub-strings that should be ignored when generating/identifying templates, which is further described below. For effective template generation (e.g., to obtain optimal templates from titles), it may be preferable to use readable strings (e.g., strings that include words) as inputs to the template generation algorithm. However, titles may not only include readable words. Titles may also include symbols, numbers, or letters. As such, before processing a title through any template generation or template identifying algorithm, the title can be masked to remove some substrings, such as symbols or numbers, to obtain an interpretable string (e.g., a string that is semantically meaningful to a human reader).

To illustrate, and without limitations, assume that a first groupable object has a first title “CRITICAL—ticket 310846 issued” and that a second groupable object has a second title “CRITICAL—ticket 310849 issued.” The first and the second titles do not match without further text processing. However, as further described herein, the first and the second titles may be normalized to the same masked title “CRITICAL—ticket<NUMBER>issued.” As such, for purposes of identifying related objects (such as by a text similarity tool, such as the text similarity tool 504 of FIG. 5), the first groupable object and the second groupable object can be considered to be related.

A set of text processing rules may be applied to a title to obtain a masked title. In some implementations, more, fewer, other rules than those described herein, or a combination thereof may be applied. The rules may be applied in a predefined order.

A first rule may be used to replace numeric substrings, such as those that represent object identifiers, with a placeholder. For example, given the title “This is ticket 310846 from Technical Support,” the first rule can provide the masked title “This is ticket <NUMBER> from Technical Support,” where the numeric substring “310846” is replaced with the placeholder “<NUMBER>.” A second rule may be used to replace substrings identified as measurements with another placeholder. For example, given the title “Disk is 95% full in lt-usw2-dataspeedway on host:lt-usw2-dataspeedway-dskafka-03,” the second rule can provide the masked title “Disk is <MEASUREMENT> full in lt-usw2-dataspeedway on host:lt-usw2-dataspeedway-dskafka-03,” where the substring “95%” is replaced with the placeholder “<MEASUREMENT>.”

The text processing rules may be implemented in any number of ways. For example, each of the rules may be implemented as a respective set of computer executable instructions (e.g., a program, etc.) that carries out the function of the rule. At least some of the rules may be implemented using pattern matching and substitution, such as using regular expression matching and substitution. Other implementations are possible.

The template selector 702 uses a template data 712, which can include templates used for matching. The template selector 702 identifies the template 705 of the template data 712 that matches the groupable object 708 (or a title or a matched title, as the case may be, depending on the input to the template selector 702).

A template updater 714 can be used to update the template data 712. The template data 712 can be updated according to update criteria. In an example, groupable objects received within a recent time window can be used to update the template data 712. In an example, the recent time window can be 10 seconds, 15 seconds, 1 minute, or some other recent time window. In an example, the template data 712 is updated after at least a certain number of new groupable objects are created in the system 400 of FIG. 4. Other update criteria are possible. For example, the template data of different routing keys or of different managed organizations can be updated according to different update criteria.

In an example, the template updater 714 can be part of the template selector 702. As such, in the process of identifying templates for groupable objects received within the recent time window, new templates may be added to the template data 712. Said another way, in the process of identifying a type of a groupable object (based on the title or the masked title, as the case may be), if a matching template is identified, that template is used; otherwise, a new template may be added to the template data 712.

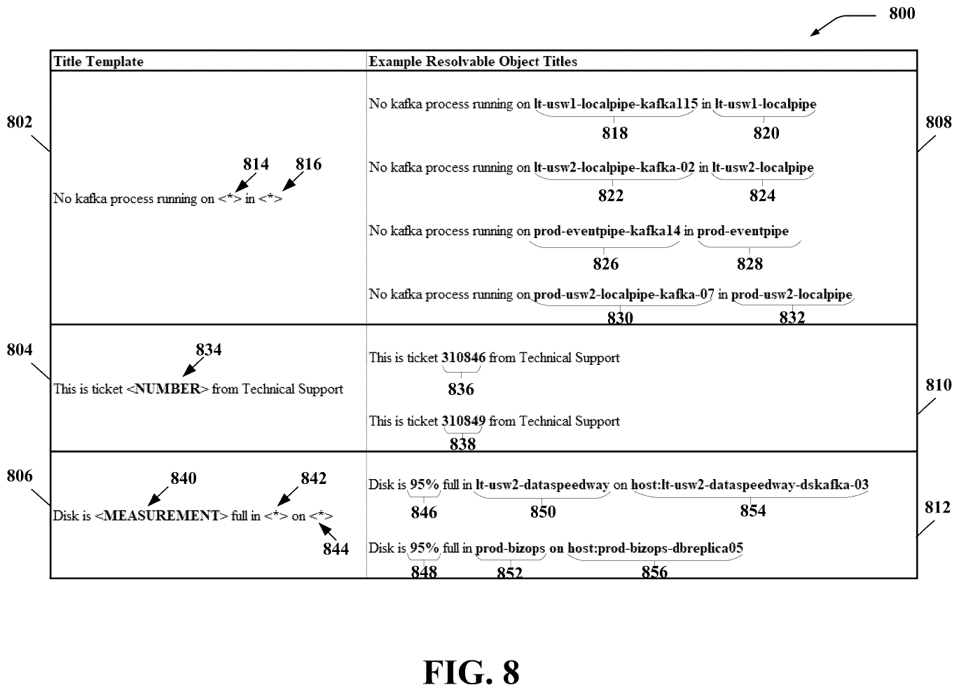

FIG. 8 illustrates examples 800 of templates. Templates can be obtained from titles or masked titles, as the case may be. FIG. 8 illustrates three templates; namely templates 802-806. The templates 802, 804, 806 may be derived from (i.e., at template update time) or may match (i.e., at classification time) the title groups 808, 810, 812, respectively.

As mentioned above, templates include constant parts and variable parts. The constant parts of a template can be thought of as defining or describing, collectively, a distinct state, condition, operation, failure, or some other distinct semantic meaning as compared to the constant parts of other templates. The variable parts can be thought of as defining or capturing a dynamic, or variable state to which the constant parts apply.

To illustrate, the template 802 includes, in order of appearance in the template, the constant parts “No,” “kafka,” “process,” “running,” and “in;” and includes variable parts 814 and 816 (represented by the pattern <*> to indicate substitution patterns). The variable part 814 can match or can be derived from substrings 818, 822, 826, and 830 of the title group 808; and the variable part 816 can match or can be derived from substrings 820, 824, 828, and 832 of the title group 808. The template 804 does not include variable parts. However, the template 804 includes a placeholder 834, which is identified from or matches a mask of numeric substrings 836 and 838, as described above. The template 806 includes a placeholder 840 and variable parts 842, 844. The placeholder 840 can result from or match masked portions 846 and 848. The variable part 842 can match or can be derived from substrings 850 and 852. The variable part 844 can match or can be derived from substrings 854 and 856.

In obtaining templates from titles or masked titles, as the case may be, such as by the template updater 714 of FIG. 7, it is desirable that the templates include a balance of constant and variable parts. If a template includes too many constant parts as compared to the variable parts, then the template may be too specific and would not be usable to combine similar titles together into a group or cluster for the purpose of classification. Such a template can result in false negatives (i.e., unmatched titles that should in fact be identified as similar to other titles). If a template includes too many variable parts as compared to the constant parts, then the template can practically match titles even though they are not in fact similar. Such templates can result in many false positive matches.

To illustrate, given the title “vednssoa04.atlqa1/keepalive: No keepalive sent from client for 2374 seconds (>=120),” a first algorithm may obtain a first template “vednssoa04.atlis1/keepalive: No keepalive sent from client for <*> seconds <*>,” a second algorithm may obtain a second template “<*>: <*><*><*><*> client <*><*><*><*>,” and a third algorithm may obtain a third template “<*>: No keepalive sent from client for <*> seconds <*>.” The first template capturers (includes) very few parameters as compared to the constant parts. The second template includes too many parameters. The third template includes a balance of constant and variable parts.

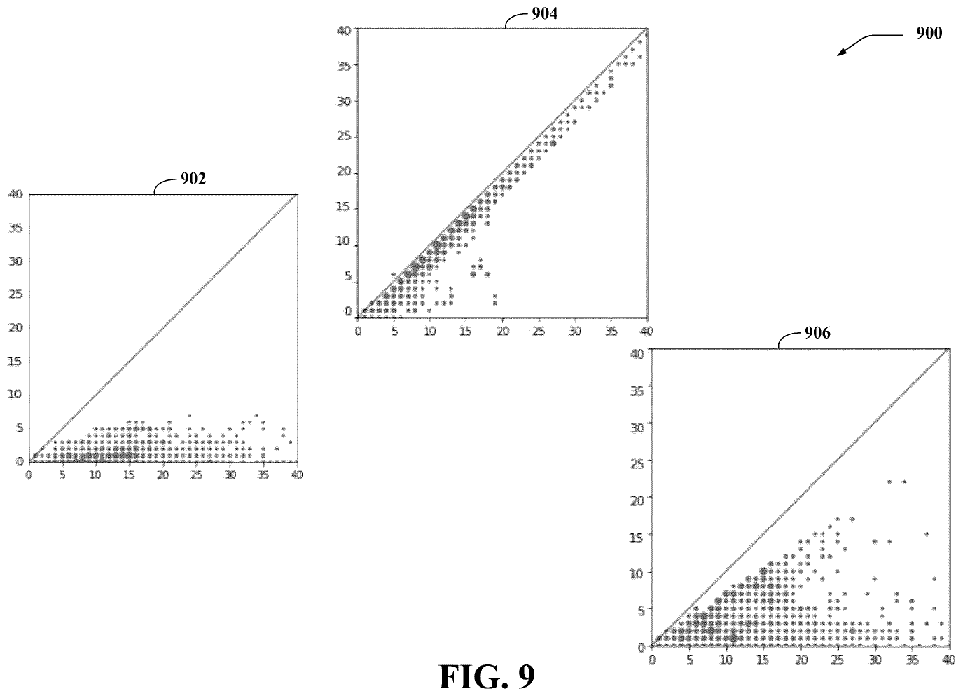

FIG. 9 illustrates plots 900 of results of algorithms that generate optimal and sub-optimal templates. The plots 900 includes a first scatter plot 902 corresponding to the first algorithm mentioned above, a second scatter plot 904 corresponding to the second algorithm mentioned above, and a third scatter plot 906 corresponding to the third algorithm mentioned above. The scatter plots of FIG. 9 plot the number of tokens (i.e., the x-axis) in titles against the number of parameters (i.e., the variable parts) in the corresponding templates on the y-axis obtained using the algorithm corresponding to the plot. For example, the title “No kafka process running on lt-usw1-localpipe-kafka115 in lt-usw1-localpipe” includes 8 tokens and the corresponding title “No kafka process running on <*> in <*>” includes 2 parameters.

As already alluded to, algorithms that result in too many points close to the x-axis or close to the diagonal line are undesirable. A scatter plot (such as the first scatter plot 902) that includes too many points close to the x-axis can mean that there are not many parameters in the obtained templates. A scatter plot (such as the second scatter plot 904) that includes too many points close to the diagonal line can mean that almost all tokens of titles are mapped to parameters. Contrastingly, and desirably, the scatter plot 906 does not exhibit either of the preceding conditions. As such, the templates obtained using the third algorithm can be considered to be better templates than the templates obtained using the first and the second algorithms. Templates may be expected to include more constant parts than variable parts. As such, it can be expected that most points may be below the diagonal line. It is noted that the size of a point in the scatter plots of FIG. 9 is an indicator for the number of the titles that have the same number of tokens and parameters.

Referring again to FIG. 7, the template selector 702 can be implemented in any number of ways. In an example, a log-parsing technique or algorithm can be used to obtain templates from groupable objects. In an implementation, the technique or algorithm used can be an off-line technique or algorithm in which obtaining templates to match against and matching titles to templates are separate steps (e.g., separated in time) where obtaining additional templates can be a batch off-line process. In an implementation, the technique or algorithm used can be an on-line technique or algorithm in which an initial set of templates may be obtained using a batch process and new templates are obtained from titles received for matching in real-time or in near real-time.

As described with respect to FIG. 7, in the case of an off-line processor (parser) the template updater 714 may be separate from the template selector 702; and in the case of an on-line processor (parser), the template updater 714 may be part or, combined with, or works in conjunction with the template selector 702. As such, responsive to new groupable data (i.e., titles or masked titles therefor) received at the template selector 702 therein of FIG. 7, the template data 712 can be recalculated (e.g., regenerated or updated) by (e.g., according to, to incorporate, etc.) any new groupable data. As such, the template selector 702 not only applies existing templates of the template data 712 for matching, the template selector 702 can also update the template data 712 to include new templates, which may be influenced by the groupable data (or a subset thereof).

In an example, obtaining the template may be delayed (e.g., deferred) for a short period of time until the template data 712 is updated based on most recently received groupable objects according to an update criterion. The update criterion can be time based (i.e., a time-based criterion), count based (i.e., a count-based criterion), other update criterion, or a combination thereof. In example, the update criterion may be or may include updating the template data 712 at a certain time frequency (e.g., every 15 seconds or some other frequency). In example, the update criterion may be or may include updating the template data 712 after a certain number of new groupable objects are received (e.g., every 100, 200, more or fewer new groupable objects are received). In an example, if the count-based criterion is not met within a threshold time, then the template data 712 is updated according the new groupable objects received up to the expiry of the threshold time. To illustrate, and without limitations, assume that the update criterion is set to be or equivalent to “every 75 new objects” and that a new groupable object is the 56^{th} object received in the update window. A template is not obtained for the this groupable object until after the 75^{th} groupable object is received and the template data 712 is updated using the 75 new objects.

Examples of techniques or algorithms that may be used include, but are not limited to using well known techniques such as regular expression parsing, Streaming structured Parser for Event Logs using Longest common subsequence (SPELL), Simple Logfile Clustering Tool (SLECT), Iterative Partitioning Log Mining (IPLoM), Log File Abstraction (LFA), Depth tRee bAsed onlIne log parsiNg (DRAIN), or other similar techniques or algorithms. At least some of these algorithms or techniques are machine learning techniques that use unsupervised learning to learn (e.g., incorporate) new templates in their respective models based on new received data. In an example, DRAIN may be used. A detailed description of DRAIN or any of the other algorithms is not necessary as a person skilled in the art is, or can easily become, familiar with log parsing techniques, including DRAIN, which is a machine learning model that uses unsupervised learning. However a general overview of DRAIN is now provided.

DRAIN organizes templates into a parse tree with a fixed depth. Each first level node (i.e., each node in the first layer of the parse tree) corresponds to a template length and all leaf nodes can have the same depth. The depth of the parse tree can be set as a configuration. DRAIN organizes the groupable objects into clusters (or groups) where each group is represented by a template. As such, each cluster can include multiple groupable objects that match the template of the cluster. Each leaf node can include multiple templates.

To identify a template matching a received groupable object (or title or masked title), DRAIN traverses the parse tree by following the branch that corresponds to the length of the groupable object (i.e., the title or the masked title, as the case may be). DRAIN selects a next internal node by matching a token in a current position of a title to a current internal node of the parse tree. When a lead node is reached, DRAIN calculates a similarity between each template at the leaf node and the groupable object to be matched according to formula (1). In formula (1), seq₁ and seq₂ represent the title (or masked title) of the groupable object and a template, respectively; seq(i) represents an i^{th} token; n is the template length; t₁ and t₂ are two tokens, and equ( ) is a function that accepts two tokens as inputs and output a 1 if the input tokens are equal and a 0 if the inputs tokens are not equal.

$$\begin{matrix}simSeq = {\sum }_{i = 1}^{n} e q u ( s e {q}_{1} ( i ) , s e {q}_{2} ( i ) ) / n \\ equ ( {t}_{1} , {t}_{2} ) = \{ \begin{matrix}1 & if {t}_{1} = {t}_{2} \\ 0 & otherwise\end{matrix}\end{matrix} \qquad ( 1 )$$

DRAIN selects the most suitable template from amongst the templates at the leaf node. The most suitable template is the template with the largest calculated simSeq value. If the maximum simSeq is greater than a threshold, then the template is selected (e.g., identified) for the groupable object. The threshold can be 60% or some other threshold value. If no suitable template is identified, a new cluster (i.e., a new template) is created based on the current groupable object.

FIG. 10 is a diagram of a technique 1000 for training and using a graph-based neural network, such as the graph-based neural network 506 of FIG. 5. Graph-based neural networks are a sub-class of embedding neural network models that can transform an object (e.g., a word, an image, details (e.g., specifications) of a product, a sentence, or any other object, such as an alert) into a vector of numbers. Transforming objects into vectors can be useful because vectors have properties that enable use cases such as computing similarity, grouping, ranking, classification, and the like. Objects can be compared by comparing their respective vectors using, for example, cosine similarity. Transforming an object into a vector is referred to as embedding. Transforming an object into an embedding means obtaining a numerical representation of the object.

As mentioned above, vectorization techniques can be used by the text similarity tool 504 of FIG. 5. In that context, vectorization refers to word count vectorization of textual tokens. However, text similarity through comparing word count vectors does not necessarily convey semantics or meaning. Contrastingly, vectorization through embedding with a graph-based neural network can result in emergent properties that resemble semantics.

Embedding words in a vector space can help a learning algorithm to achieve better performance in natural language processing. Word2Vec is a popular algorithm that can be used to learn vector representations of words (and is extended herein to sentences). As is known, Word2Vec can predict the occurrence of a target word in a corpus (large volumes of text) given a context (herein, the domain of alerts). The learned vectors can encode many linguistic regularities and patterns, which could be represented as linear translations. For example, a Word2Vec model can learn that: vector(“king”)−vector(“man”)+vector(“woman”)≈vector(“queen”). Word2Vec outputs embedding vectors. An emergent property of these embedding vectors is that similar words will have similar embeddings.

In the context of this disclosure, a model that is based on (e.g., is an extension of) Word2Vec can be trained to define (or understand) an alert context by defining sentence equivalents. As the famous saying “You shall know a word by the company it keeps” goes, “You shall know [an alert] by the company it keeps.” The former sentence means that the meaning of a word can be understood in relation to, or based on, the context it is used in; the later sentence means that whether an alert is similar to another is based on historical co-occurrences of the alert and the other alert.

Accordingly, the process 1000 for training and using a graph-based neural network includes steps for joining (at 1002) groupable data (e.g., alert data, event data, or both) through time; creating (at 1004) a combined graph; creating (at 1006) random walks; applying (at 1008) the graph-based neural network; and using (at 1010) embeddings generated from the neural network using vector similarity. Aline 1012 indicates a separation between a training phase (steps above the line 1012) and an inference phase (steps below the line 1012) of the graph-based neural network.

At 1002, the groupable data are joined through time. Any number of techniques can be used to join the groupable data through time. Each group of groupable objects is referred to herein as a sample. Described herein are two techniques for joining groupable data through time. For ease of reference, the described techniques are referred to as object-based (e.g., alert-based) grouping and time-window-based grouping. However, the disclosure is not limited to or by these two techniques and other ways of obtaining samples are possible. For example, machine-learning techniques that are based on association rule learning may be used to generate samples where associations between groupable objects may be learned (e.g., discovered or inferred) based on measures of interestingness (e.g., relatedness) between groupable objects. As further described herein, respective relationship graphs are obtained from the samples and a combined graph is then obtained from the respective relationship graphs.

In the object-based grouping, at least some groupable objects are used as respective starting points for collecting (e.g., generating) samples. A groupable object may be associated with an active window. The active window can be defined by a start time and an end time. The start time may be the time of creation (e.g., instantiation) of the groupable object. The end time may be defined by an offset time (e.g., 5 minutes or 10 minutes) from the start time. The groupable object starts a new group. Other groupable objects received within the time window between the start time and the end time are added to the same sample.

In an example, the end time can be extendable. For example, if a groupable object is created within an extension threshold of the end time, then the end time can be extended by an extension time, which can be equal to the offset time or can be some other extension threshold. To illustrate, assume that the active window is configured to be equal to 10 minutes and that the extension threshold is configured to be equal 1 minute. Assume further that an alert is received at a time T. As such, a new sample is started, the alert is added to the sample, and the active window associated with the sample is set to (T+10). If no alerts are received between the 9^{th} and 10^{th} minute after T, then the sample is closed (i.e., no more alerts are added to it); on the other hand, if a new alert is received at (T+9:44), then the new alert is added to the sample and the active window may be extended to, for example, (T+20).

In an example, the samples may be overlapping. If a new groupable object is created within the active window of another groupable object, then the new groupable object is added to the sample started by the other groupable object and a new sample, to which the new groupable is also added, is also started. In another example, the samples may be non-overlapping. Any new groupable object created within the active window of another groupable object is only added to the sample started by that other groupable object. No new samples are started until the active window of the other alert is closed.

In an example, some groupable objects (e.g., alerts) may be considered noisy (e.g., noisy alerts) and are either not added to samples or removed from samples (after the samples are created). To illustrate, an alert may be identified as (e.g., pre-determined to be) noisy if many instances of the alert are being triggered and/or are being added to a threshold number of samples.

In the time-window-based grouping, groupable data (e.g., alerts) received through time are grouped (e.g., binned) by time windows of a predefined width (e.g., 5 minutes or 10 minutes). In an example, the time windows can be non-overlapping. In an example, the time windows can be overlapping (i.e., sliding windows). The time windows can be overlapped based on a stride value (e.g., 15 seconds or 30 seconds). The groupable data within a window constitute a sample.

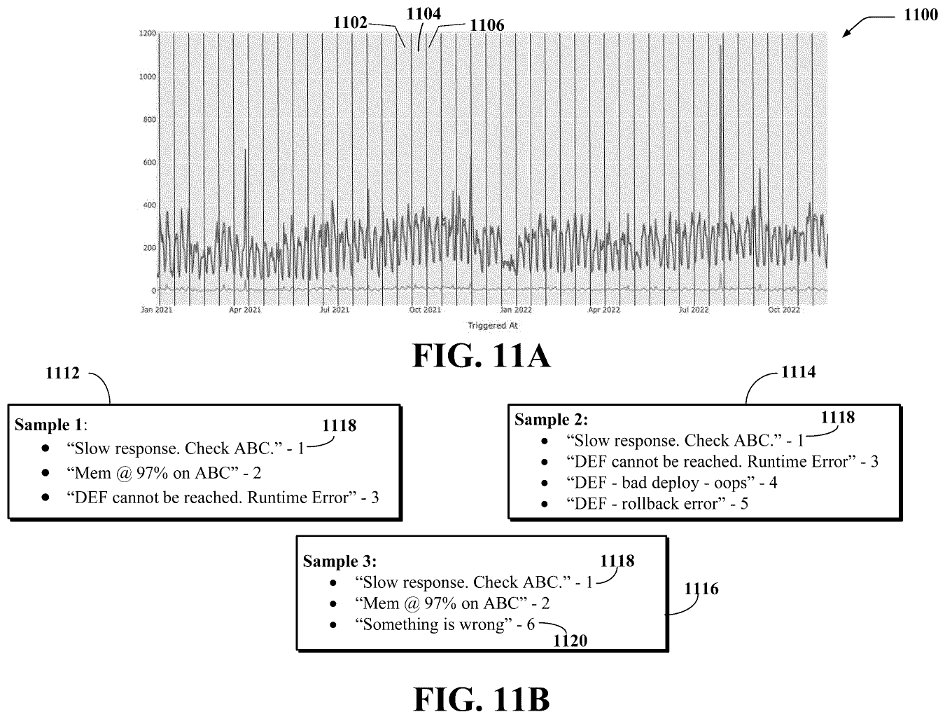

FIGS. 11A-11B illustrate an example 1100 of joining groupable data through time. The example 1100 illustrates joining groupable data through time using the time-window-based grouping technique. FIG. 11A illustrates that groupable data are grouped using non-overlapping windows, such as windows 1102-1106. FIG. 11B illustrates examples of samples of groupable data. A sample 1112 includes titles of the groupable objects of the time window 1102; a sample 1114 includes titles of the groupable objects of the time window 1104; and a sample 1116 includes titles of the groupable objects of the time window 1106. Each of the unique titles is associated with a unique identifier. For example, an alert title 1118 (i.e., “Slow response. Check ABC.”), which, in this example, happens to be repeated in each of the samples 1112, 1114, 1116, is assigned the identifier “1”; and an alert title 1120 (i.e., “Something is wrong”), which is included in the sample 1116, is assigned the identifier “6.” The titles within each sample are assumed to be related to each other. However, at this point, the strengths of such relationships are not known.

At 1004 of FIG. 10, a relationship graph is created from the samples. In a first step, a graph for each sample (i.e., a sample graph) may be constructed, and in a second step, the graphs of all the samples are combined into a single graph. A graph can be represented in any suitable data structure.

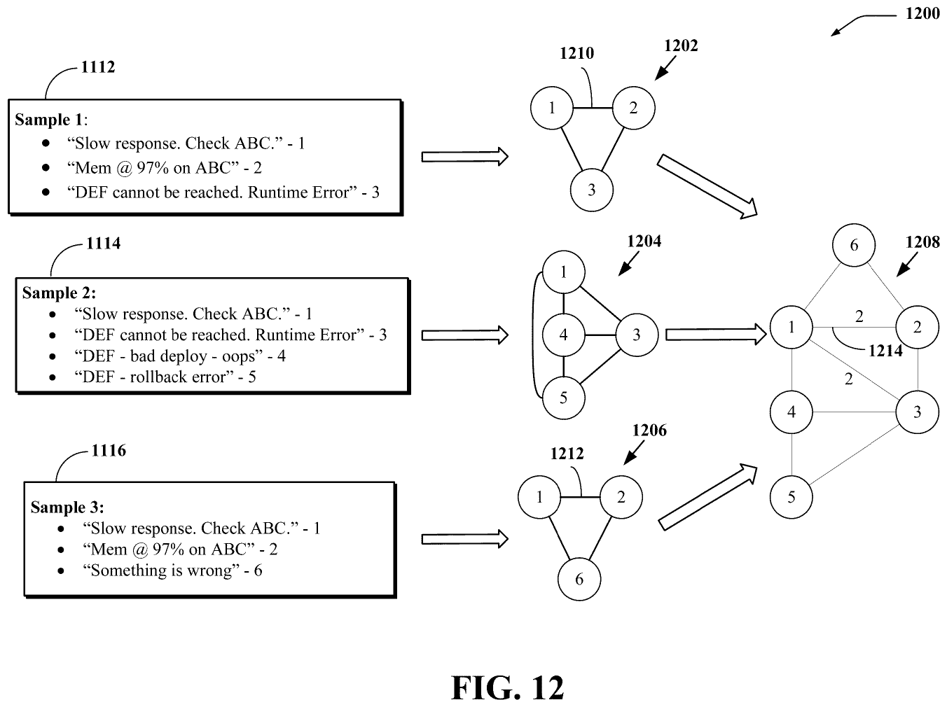

FIG. 12 illustrates an example 1200 of creating a relationship graph. For ease of reference, the samples 1112-1116 of FIG. 11B are also shown in FIG. 12. Sample graphs 1202, 1204, 1206 are constructed from the alert titles of the samples 1112, 1114, 1116. Each node of a sample graph is shown as being labeled with the identifier of the corresponding title. In each sample graph, every node is connected to every other node. To illustrate, in the sample graph 1204, each of nodes labeled 1, 3, 4, and 5 is connected to every other node. All of the sample graphs are then combined into a combined graph 1208. As can be appreciated, even though the graphs 1202, 1204, and 1206 and the combined graph 1208 are obtained from the samples 1112, 1114, and 1116, which are obtained using the time-window-based grouping technique, such graphs can be obtained regardless of the technique used to obtain the samples. That is, the graphs can be similarly obtained if object-based grouping (or any other technique) were used to obtain the samples.

The edges of the combined graph 1208 include weights. The weights reflect the number of times that two nodes of the combined graph 1208 are related in the sample graphs. To illustrate, as node 1 and node 2 are connected twice (in the sample graphs 1202 and 1206, as indicated by edges 1210 and 1212, respectively), the edge 1214 of the combined graph 1208 is shown as having a weight of two (2). For brevity, weights of one (1) are not shown in the combined graph 1208.

While, for simplicity of explanation, the sample graphs 1210-1206 and the combined graph 1208 include a limited number of nodes and edges, in reality, such graphs, especially when aggregated over 100s, 1000s, or more of time windows, may aggregate into massive graphs and some of the connections may be repeated many number of times. This massive graph better incorporates (or reflects) the true strength of the relationships between nodes (i.e., between the alert titles).

At 1006 of FIG. 10, the combined graph 1208 of FIG. 12 is randomly traversed to create random walks. A predefined number m of random walks are obtained; and each random walk can be generated using a predefined number n of steps (i.e., hops). A random walk can start at a randomly selected node (which represents an alert title) of the combined graph 1208. A next node to be visited can be probabilistically selected based on the weights of the edges that emanate from the node. To illustrate, starting at the node labeled 1, there is a 16.7%, 33.33%, 33.33%, and 16.7% probability of selecting the node labeled 6, 2, 3, and 4, respectively, as the next node in the random walk. The process repeats for n hops (i.e., until n+1 nodes are visited or until n edges are traversed).

In the context of Word2Vec, a random walk (even though it in fact includes multiple sentences) can be thought of as being equivalent to a sentence; and a node (even though it may be composed of multiple words) can be thought of as being equivalent to a word. Examples of random walks, where m=3 and n=4, can be 1→3→5→6, 6→2→1→3, and 1→4→5→3.

At 1008 of FIG. 10, the graph-based neural network is applied to (i.e., is trained on) the sentences that result from the random walks. For example, Word2Vec-based algorithm can be run based on the walks (i.e., sentences), which will return embeddings of each of alert titles. In an example, the DeepWalk can be used. As is known, DeepWalk can be used to learn latent representations of vertices in a network (e.g., graph). These latent representations encode relations in a continuous vector space. The vector space can then be exploited by statistical models. In an example, Node2Vec can be used. Node2Vec can be used to learn a mapping of nodes in a graph to a low-dimensional space of features that maximizes the likelihood of preserving network neighborhoods of nodes in a graph. As such, in an example, steps 1006 and 1008 may be combined, as illustrated by a box 1009, such as in the case that the combination of DeepWalk and Node2Vec are used because they can create random walks of a graph and input the random walks to Word2Vec.

At 1010, after the graph-based neural network has been trained, it can be used to identify related groupable objects. That is, the embeddings generated from the graph-based neural network can be used to identify related alerts (or, more generally, groupable objects). More specifically, in response to receiving an alert, the graph-based neural network can be used to obtain an embedding for the incoming alert. The embedding of the incoming alert can be compared to the embeddings of the subset of incidents that are currently active and that qualify for comparison to the incoming alert. The incidents that qualify for comparison are those that the incoming alert can be grouped with, as illustratively described above with respect to file cabinets and file drawers. Comparing embeddings (using vector mathematics) can output a similarity score. The incoming alert can then be grouped with the open incident that results in the highest similarity score.

In another example, instead of generating random walks of alert titles and obtaining embeddings for alert titles, random walks of alert templates (which can be as described above) can be used and embeddings can be obtained for alert templates. As such, instead of obtaining an embedding for the title itself of the incoming alert, an embedding can be obtained for a template identified for the alert. In either case, and for brevity, generating a random walk of alerts also includes generating a random walk of alert templates associated with the alerts; and obtaining an embedding of an alert includes obtaining an embedding of a template associated with the alert.

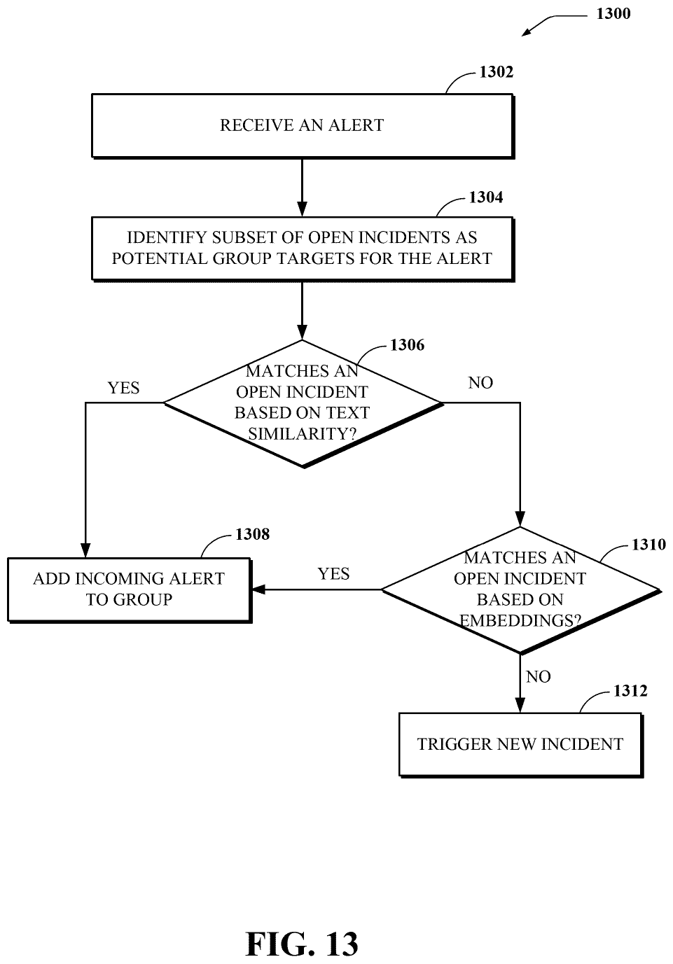

FIG. 13 is a flowchart of an example of a technique 1300 for grouping alerts. The technique 1300 can be implemented in or by an EMB, such as the system 400 of FIG. 4. The technique 1300 may be implemented in whole or in part in or by a related objects identifier, such as one of the related objects identifier software 418A, 418B of the system 400 of FIG. 4, or the related-objects identifier software 500 of FIG. 5.

The technique 1300 can be implemented, for example, as a software program that may be executed by computing devices such as the network computer 300 of FIG. 3. The software program can include machine-readable instructions that may be stored in a memory (e.g., a non-transitory computer readable medium), such as the memory 304, the processor-readable stationary storage device 334, or the processor-readable removable storage device 336 of FIG. 3, and that, when executed by a processor, such as the processor 302 of FIG. 3, may cause the computing device to perform the technique 1300. The technique 1300 can be implemented using specialized hardware or firmware. Multiple processors, memories, or both, may be used.

At 1302, an incoming alert is received. As described above, the incoming alert can be triggered (e.g., created or instantiated or received in any other way) in response to an received event. At 1304, a CBAG tool, such as the CBAG tool 502 of FIG. 5, identifies a subset of open incidents that the alert may potentially be grouped under. The CBAG tool identifies which of the CBAG rules the incoming alert (i.e., the fields of the incoming alert) matches. If the incoming alert matches a CBAG rule, then the technique 1300 identifies incidents corresponding to the matched rule as potential grouping targets for the alert. if the alert does not match any CBAG rules, then default incidents are identified as potential grouping targets. A default incident is an incident that is triggered from an alert that does not match any CBAG rules. In another example, default incidents (file cabinets) are created when the CBAG tool is not enabled.

At 1306, a text similarity tool, such as the text similarity tool 504 of FIG. 5, determines which of the potential grouping targets the incoming alert matches, such as described with respect to the template selector 702 of FIG. 7. If the incoming alert matches an open incident of the potential grouping targets, then the technique 1300 proceeds to 1308 to group the incoming alert under the incident. If the incoming alert does not match an open incident, then the technique 1300 proceeds to 1310.

At 1310, a graph-based neural network, such as the graph-based neural network 506 of FIG. 5, is used to obtain an embedding for the incoming alert and the embedding is compared to the embeddings of the open incidents. The embedding of the incoming alert is matched (such as using cosine similarities) to the embeddings of the open incidents to obtain respective match scores. The maximum match score is selected and compared to a threshold match score. If the maximum match score exceeds the threshold match score, then the incoming alert is considered to match the incident corresponding to the maximum match score. If the incoming alert is determined to match an open incident based on a comparison of embeddings, then, at 1308, the alert is grouped under the incident; otherwise, the technique 1300 proceeds to 1312 to trigger a new incident from the alert, as the alert is a first-of-its-kind alert.

As mentioned above, determining whether an incoming alert matches an incident can be performed in any in any number of ways. In an example, the title (or template) of the incoming alert can be matched (i.e., compared to) the title (or template) of the first-of-its-kind alert that triggered the incident. In an example, the title (or template) of the incoming alert can matched to the title (or template) of the last alert to be grouped under the incident. In an example, the title (or template) of the incoming alert can be matched to the title (or template) of a randomly selected alert that is grouped under the incident. Other ways of determining whether a received alert matches an incident are possible, as described herein.

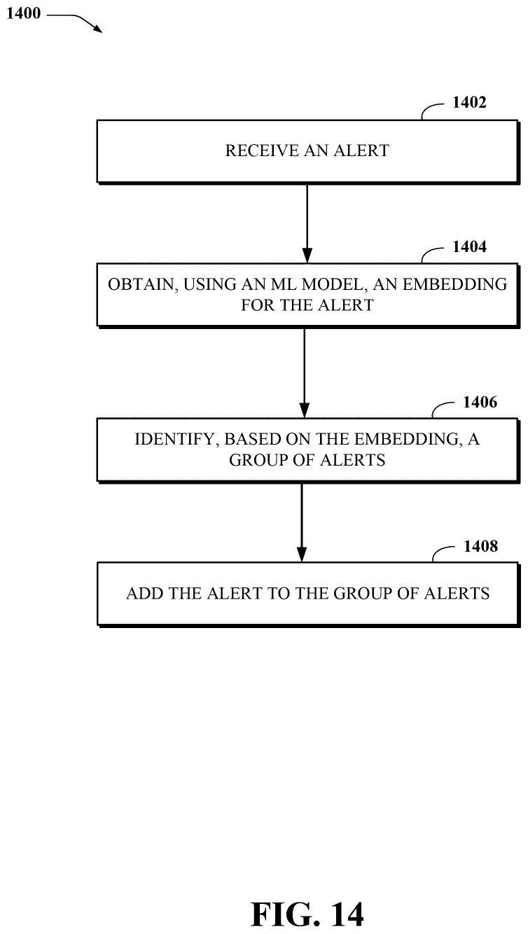

FIG. 14 is a flowchart of an example of a technique 1400 for grouping alerts. The technique 1400 can be implemented in or by an EMB, such as the system 400 of FIG. 4. The technique 1400 may be implemented in whole or in part in or by a related objects identifier, such as one of the related objects identifier software 418A, 418B of the system 400 of FIG. 4, or the related-objects identifier software 500 of FIG. 5.

The technique 1400 can be implemented, for example, as a software program that may be executed by computing devices such as the network computer 300 of FIG. 3. The software program can include machine-readable instructions that may be stored in a memory (e.g., a non-transitory computer readable medium), such as the memory 304, the processor-readable stationary storage device 334, or the processor-readable removable storage device 336 of FIG. 3, and that, when executed by a processor, such as the processor 302 of FIG. 3, may cause the computing device to perform the technique 1400. The technique 1400 can be implemented using specialized hardware or firmware. Multiple processors, memories, or both, may be used.

At 1402, an (incoming) alert is received. The alert can be received (e.g., created, instantiated, triggered) as described above. At 1404, an embedding is obtained for the alert using an ML model, such as the graph-based neural network 506 of FIG. 5. At 1406, a group of alerts is identified based on the embedding. At 1408, the alert is added to the identified group of alerts. As described above, identifying a group of alerts based on the embedding can mean identifying an incident that corresponds to the group of alerts. As also described above, identifying the group of alerts based on the embedding can mean comparing the embedding of the alert to at least one embedding of an alert of the group of alerts.

As described above, the ML model can be trained by obtaining training data where each training datum includes a series of alert texts obtained from historical alerts; and the ML model is then trained using the training data to output embedding for alert texts. The training data can be obtained by grouping the historical alerts into samples of alerts, such as described above with respect to FIGS. 11A and 11B. Respective graphs can be generated for the samples of alerts and the respective graphs are then combined into a combined graph, such as described with respect to FIG. 12. Random walks of nodes of the combined graph can be obtained, such as described with respect to above. Each random walk corresponds to a training datum and includes respective texts of the nodes of the random walk. In an example, the historical alerts can be grouped into the samples of alerts based on overlapping sliding windows over the historical alerts. In an example, non-overlapping windows can be used, as described above. In an example, at least some of the historical alerts can be grouped into a sample associated with a historical alert based on an active window associated with the historical alert, as described above.

In an example, the technique 1300 can include receiving another alert. The technique 1300 determines that the other alert cannot be grouped into any other group of alerts by comparing an embedding of the other alert obtained using the ML model to respective embeddings of the group of alerts. In response to the determination, a new group can be created and the other alert is added to the new group. As described above, creating a new group can mean triggering an new incident for the other event. The determination indicates that the other event is a first-of-its-kind, as described above.

In an example, the technique 1300 can include receiving yet another alert and determines whether the other alert matches any group of alerts using a text similarity tool, such as the text similarity tool 504 of FIG. 5. Responsive to determining, using the text similarity tool, that the other alert does not match any group of alerts, the ML model can be used to determine whether the other alert matches any of the any group of alerts. If the other alert does not match any group of alerts, the other alert can be added to a new group of alerts (e.g., a new incident can be triggered). On the other hand, if the other alert is determined to match a group of alerts, then the second alert is added to the group of alerts. As described above with respect to the ML model, that an alert matches a group of alerts means that the embedding of the alert meets a similarity threshold with the embedding of one (e.g., a representative) alert of the group of alerts.

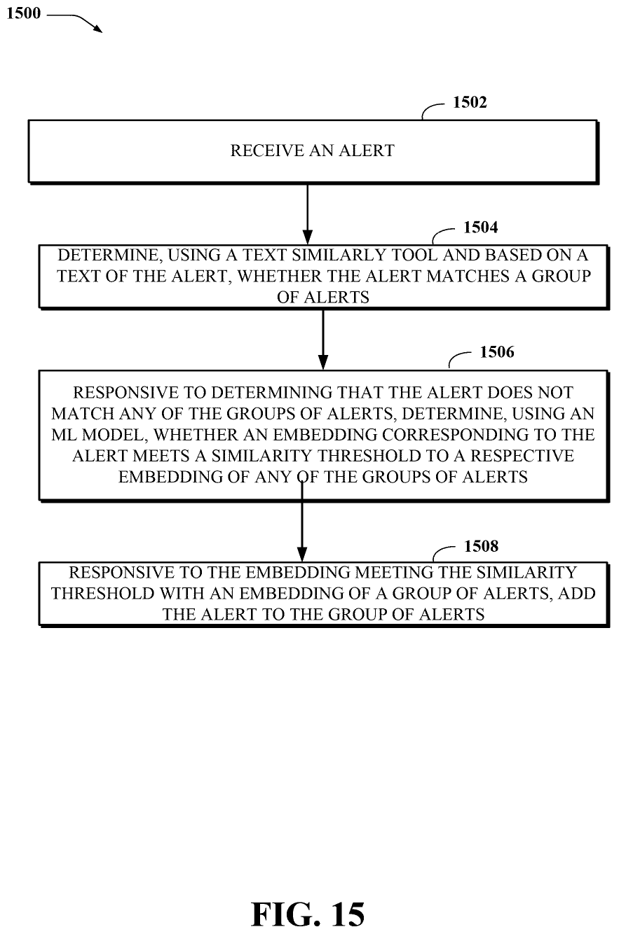

FIG. 15 is a flowchart of an example of a technique 1500 for grouping alerts. The technique 1500 can be implemented in or by an EMB, such as the system 400 of FIG. 4. The technique 1500 may be implemented in whole or in part in or by a related objects identifier, such as one of the related objects identifier software 418A, 418B of the system 400 of FIG. 4, or the related-objects identifier software 500 of FIG. 5.

The technique 1500 can be implemented, for example, as a software program that may be executed by computing devices such as the network computer 300 of FIG. 3. The software program can include machine-readable instructions that may be stored in a memory (e.g., a non-transitory computer readable medium), such as the memory 304, the processor-readable stationary storage device 334, or the processor-readable removable storage device 336 of FIG. 3, and that, when executed by a processor, such as the processor 302 of FIG. 3, may cause the computing device to perform the technique 1500. The technique 1500 can be implemented using specialized hardware or firmware. Multiple processors, memories, or both, may be used.

At 1502, an alert is received. At 1504, a text similarly tool, such as the text similarity tool 504 of FIG. 5, is used to determine whether the alert matches a group of alerts based on a text of the alert. At 1506, if the text similarly tool determines that the alert does not match any group of alerts, an ML model, such as the graph-based neural network 506 of FIG. 5, is used to determine whether an embedding corresponding to the alert meets a similarity threshold to a respective embedding of any of the groups of alerts. At 1508, if the embedding meets the similarity threshold with an embedding of a group of alerts, the alert is added to the group of alerts. If the embedding does not meet the similarity threshold with any embedding of any of the groups of alerts, then a new group of created, to which the alert is then added. The ML model can be trained as described above.

For simplicity of explanation, the techniques 1300, 1400, and 1500 of FIGS. 13, 14, and 15, respectively, are each depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

For example embodiments, the following terms are also used herein according to the corresponding meaning, unless the context clearly dictates otherwise.

As used herein the term, “software” refers to logic embodied in hardware or software instructions, which can be written in a programming language, such as C, C++, Objective-C, COBOL, Java™, PHP, Perl, JavaScript, Ruby, VBScript, Microsoft .NET™ languages such as C #, and/or the like. A software may be compiled into executable programs or written in interpreted programming languages. Software may be callable from other software or from themselves. Software described herein refer to one or more logical modules that can be merged with other software or applications, or can be divided into sub-software or tools. The software can be stored in non-transitory computer-readable medium or computer storage devices and be stored on and executed by one or more general purpose computers, thus creating a special purpose computer configured to provide the software.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving an alert;
obtaining, using a machine-learning model, an embedding for the alert, wherein the machine-learning model is trained by steps comprising:
obtaining training data, wherein each training datum comprises a series of alert texts obtained from historical alerts; and
training the machine-learning model using the training data to output embedding for alert texts;
identifying, based on the embedding, a group of alerts; and
adding the alert to the group of alerts.

2. The method of claim 1, wherein obtaining the training data comprises:
grouping the historical alerts into samples of alerts;
generating respective graphs for the samples of alerts, wherein each historical alert of a sample of alerts is connected to every other historical alert of the sample of alerts;
combining the respective graphs into a combined graph; and
obtaining random walks of nodes of the combined graph, wherein each random walk corresponds to a training datum and includes respective texts of the nodes of the random walk.

3. The method of claim 2, wherein grouping the historical alerts into the samples of alerts comprises:
grouping the historical alerts into the samples of alerts based on overlapping sliding windows over the historical alerts.

4. The method of claim 2, wherein grouping the historical alerts into the samples of alerts comprises:
grouping at least some of the historical alerts into a sample associated with a historical alert of the historical alerts based on an active window associated with the historical alert.

5. The method of claim 1, wherein the alert is a first alert, further comprising:
receiving a second alert;
determining that the second alert cannot be grouped into any other group of alerts by comparing an embedding of the second alert obtained using the machine-learning model to respective embeddings of the group of alerts; and
in response to determining that the second alert cannot be grouped into any other group of alerts, adding the second alert to a new group.

6. The method of claim 5, wherein adding the second alert to the new group comprises:
triggering a new incident from the alert.

7. The method of claim 1, wherein the alert is a first alert, further comprising:
receiving a second alert; and
determining whether the second alert matches any group of alerts using a text similarity tool.

8. The method of claim 7, further comprising:
responsive to determining, using the text similarity tool, that the second alert does not match any group of alerts, using the machine-learning model to determine whether the second alert matches any of the any group of alerts.

9. The method of claim 8, further comprising:
responsive to determining that the second alert does not match any group of alerts, adding the second alert to a new group of alerts.

10. The method of claim 8, further comprising:
responsive to determining that the second alert matches a group of alerts, adding the second alert to the group of alerts.

11. The method of claim 10, wherein an incident corresponds to the group of alerts, and wherein adding the second alert to the group of alerts comprises:
grouping the second alert under the incident.

12. A method, comprising:
receiving an alert;
determining, using a text similarly tool and based on a text of the alert, whether the alert matches a group of alerts of groups of alerts;
responsive to determining that the alert does not match any of the groups of alerts, determining, using a machine-learning model, whether an embedding corresponding to the alert meets a similarity threshold to a respective embedding of any of the groups of alerts; and
responsive to the embedding meeting the similarity threshold with an embedding of a group of alerts, adding the alert to the group of alerts.

13. The method of claim 12, further comprising:
responsive to the embedding not meeting the similarity threshold with any respective embedding of the groups of alerts, adding the alert to a new group of alerts.

14. The method of claim 12, wherein the machine-learning model is trained by steps comprising:
obtaining training data, wherein each training datum comprises a series of alert texts obtained from historical alerts; and
training the machine-learning model using the training data to output embedding for alert texts.

15. The method of claim 14, wherein obtaining the training data comprises:
grouping the historical alerts into samples of alerts;
generating respective graphs for the samples of alerts, wherein each historical alert of a sample of alerts is connected to every other historical alert of the sample of alerts;
combining the respective graphs into a combined graph; and
obtaining random walks of nodes of the combined graph, wherein each random walk corresponds to a training datum and includes respective texts of the nodes of the random walk.

16. The method of claim 15, wherein grouping the historical alerts into the samples of alerts comprises:
grouping the historical alerts into the samples of alerts based on overlapping sliding windows over the historical alerts.

17. The method of claim 15, wherein grouping the historical alerts into the samples of alerts comprises:
grouping at least some of the historical alerts into a sample associated with a historical alert of the historical alerts based on an active window associated with the historical alert.

18. A device, comprising:
a memory; and
a processor, the processor configured to execute instructions stored in the memory to:
receive an alert;
obtain, using a machine-learning model, an embedding for the alert, wherein the machine-learning model is trained to:
obtain training data, wherein each training datum comprises a series of alert texts obtained from historical alerts; and
output embedding for alert texts;
identify, based on the embedding, a group of alerts; and
add the alert to the group of alerts.

19. The device of claim 18, wherein to obtain the training data comprises to:
group the historical alerts into samples of alerts;
generate respective graphs for the samples of alerts, wherein each historical alert of a sample of alerts is connected to every other historical alert of the sample of alerts;
combine the respective graphs into a combined graph; and
obtain random walks of nodes of the combined graph, wherein each random walk corresponds to a training datum and includes respective texts of the nodes of the random walk.

20. The device of claim 19, wherein to group the historical alerts into the samples of alerts comprises to:
group the historical alerts into the samples of alerts based on overlapping sliding windows over the historical alerts.
